(19) United States
(12) Patent Application Publication
(10) Pub. No.: US 2024/0249275 A1
(43) Pub. Date: Jul. 25, 2024

(54) GROUP SIGNATURES FOR A SMART WALLET ON A BLOCKCHAIN PLATFORM

(71) Applicant: 0Chain Corp., Cupertino, CA (US)

(72) Inventors: Saswata Basu, Cupertino, CA (US); Siva Dirisala, Cupertino, CA (US)

(21) Appl. No.: 18/593,877

(22) Filed: Mar. 2, 2024

Related U.S. Application Data
(63) Continuation-in-part of application No. 17/349,779, filed on Jun. 16, 2021.
(63) Continuation-in-part of application No. 17/497,902, filed on Oct. 9, 2021.
Application No. 17/497,902 is a continuation-in-part of application No. 17/307,073, filed on May 4, 2021, now Pat. No. 11,637,709.
Application No. 17/307,073 is a continuation-in-part of application No. 16/247,994, filed on Jan. 15, 2019, now Pat. No. 11,171,791.

(51) Int. Cl. G06Q 20/36; G06Q 20/38; H04L 9/32

(52) U.S. Cl. CPC G06Q 20/3674; G06Q 20/3825; G06Q 20/389; H04L 9/3255

(57) ABSTRACT

An approach is disclosed for preventing changing and executing of a multi-signature smart wallet until a group key is signed with a threshold number of signatures. Creating, by a client, k out of n public-private key pairs for a multi-signature smart wallet where k is a required threshold number of public-private key pairs to process the multi-signature smart contract and n is the total number of public-private key pairs. The multi-signature smart wallet is registered with the k out of n public-private key pairs in a Merkle Patricia Tree (MPT) to record a state of the multi-sig smart wallet in blockchain platform. The n public-private key pairs are sent by the client to n approvers. A signed approval of the proposal from at least k voters must be received by the multi-signature smart wallet before allowing funds from the multi-signature smart wallet to be utilized for the proposal.

If an Application Data Sheet (ADS) has been filed for this application, it is incorporated by reference herein. Any applications claimed on the ADS for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a utility application related to and claims the benefit of priority from U.S. Provisional Patent Application No. 62/707,177 filed on Oct. 24, 2017.

### BACKGROUND

The present invention relates to a computing environment, and more particularly to the technical field of multiple signature wallets.

### SUMMARY

A method for preventing changing and executing of a multi-signature smart wallet until a group key is signed with a threshold number of signatures. Creating, by a client, k out of n public-private key pairs for a multi-signature smart wallet where k is a required threshold number of public-private key pairs to process the multi-signature smart contract and n is the total number of public-private key pairs. A first transaction to register the multi-signature smart wallet is initiated by the client, on a blockchain platform with the k out of n public-private key pairs. The multi-signature smart wallet is registered in a Merkle Patricia Tree (MPT) to record a state of the multi-sig smart wallet. The n public-private key pairs are sent by the client to n approvers. A second transaction creates a proposal that utilizes the multi-signature smart wallet. A third transaction is created to request approval of the proposal. A signed approval of the proposal from at least k voters must be received by the multi-signature smart wallet before allowing funds from the multi-signature smart wallet to be utilized for the proposal.

A system is provided that implements the method for preventing changing and executing of a multi-signature smart wallet until a group key is signed with a threshold number of signatures.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention will be apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 shows a diagram illustrating an example of a system and method on a blockchain platform with intermediaries, clients and service providers;

FIG. 2 shows Table 1 and Table 2. Table 1 discloses Performance Evaluation of the CPA secure El-Gamal Encryption Scheme and disclosed Self-Encryption Scheme. Table 2 discloses Performance Evaluation of the efficient pairing-free unidirectional PRE scheme due to Chow et al., and disclosed Scheme;

FIG. 3 discloses an encrypted file access with independent audit service provider work flow illustrating different modules and functions;

FIG. 4 discloses messaging workflow to access an encrypted file and audit reporting on a blockchain platform with server-side integration;

FIG. 5 discloses messaging workflow to access an encrypted file and audit reporting on a blockchain platform with server and client-side integration;

FIG. 6 discloses messaging flow for multiple signatures smart contract implementation;

FIG. 7 is a schematic diagram of exemplary computing devices that can be used to implement the methods and systems disclosed herein;

FIG. 8 depicts a flow for setting up a multi-sig wallet;

FIG. 9 depicts a flow for registering a multi-sig wallet;

FIG. 10 depicts a flow for processing a proposal using a multi-sig wallet; and

FIG. 11 depicts a flow for approving a proposal.

### DETAILED DESCRIPTION OF THE INVENTION

Blockchain technology, sometimes also referred to as “blockchain,” is a particular type of distributed database. Blockchains can theoretically be used to store any type of data or content, but are particularly well-suited to environments in which transparency, anonymity, and verifiability are important considerations. Examples include financial projects, such as cryptocurrencies, auctions, capital management, barter economies, insurance lotteries, and equity crowd sourcing.

A blockchain, originally block chain, is a growing list of records, called blocks, that are linked using cryptography. Each block contains a cryptographic hash of the previous block, a timestamp, and transaction data (generally represented as a Merkle tree). The Merkle tree is a hash-based data structure that is a generalization of the hash list. It is a tree structure in which each leaf node is a hash of a block of data, and each non-leaf node is a hash of its children. Typically, Merkle trees have a branching factor of 2, meaning that each node has up to 2 children.

By design, a blockchain is resistant to modification of its data. This is because once recorded, the data in any given block cannot be altered retroactively without alteration of all subsequent blocks. For use as a distributed ledger, a blockchain is typically managed by a peer-to-peer network collectively adhering to a protocol for inter-node communication and validating new blocks. Although blockchain records are not unalterable, blockchains may be considered secure by design and exemplify a distributed computing system with high Byzantine fault tolerance. A Byzantine fault is a condition of a computer system, particularly distributed computing systems, where components may fail and there is imperfect information on whether a component has failed. The blockchain has been described as “an open, distributed ledger that can record transactions between two parties efficiently and in a verifiable and permanent way.”

The technology is perhaps most easily understood through a simple and familiar example, such as “BITCOIN®1,” a cryptocurrency. A cryptocurrency is not entirely dissimilar from conventional currencies and, like a traditional currency, is essentially a medium of exchange. Traditional currencies are represented by a physical object paper currency or minted coins, for example—which is “spent” by physically delivering it in the proper denominations to a recipient in exchange for a good or service.

However, for long-distance transactions, such as buying goods or services over the Internet, direct physical delivery is not feasible. Instead, the currency would have to be mailed to the recipient. However, this carries a very high risk of fraud. The recipient may simply keep the money and not deliver the purchased good or service, leaving the buyer without recourse. Instead, on-line transactions are typically carried out using electronic payment systems in which the transaction is processed, validated, and mediated by a trusted third party. This third party may be a bank, as in the case of a debit or credit card, or a third-party service functioning as an escrow agent, such as PayPal®2. Crypto currencies operate on this same principle, except that instead of using a financial institution or other third party to facilitate the transaction, the transaction is verified through a consensus reached via cryptographic proof.

Internet is a global computer network providing a variety of information and communication facilities, comprising interconnected networks using standardized communication protocols. Internet is not owned by a single entity and it operates without a central governing body. The same principles of distributed governance were applied to digital currencies by providing ability to perform digital transactions that existed without support from any underlying institution. The digital ledger that
1 BITCOIN is a trademark of Coin Legal Ltd.
2 PAYPAL is a Trademark of PayPal, Inc.
   records the transactions in a chain using a mathematical hierarchy is called a blockchain.

The current blockchain platform and related applications known to the industry fall short in multiple ways. First, there is no separation of roles on the blockchain based on the role of an entity for a given transaction. Each transaction follows a strict chain of rules and is dependent on its preceding transaction. If one transaction fails, all subsequent transactions on the blockchain become unusable. The computing time and built-in delay in any blockchain platform is dependent on the available computing resources of its nodes. In absence of a role model, a single node has several computing intense tasks that are slow to execute. A slow system becomes vulnerable and becomes open to attacks. The current solutions do not allow for client flexibility in developing distributed applications with immutability and finality of transactions on a blockchain platform.

In order to overcome the deficiencies of the prior art, various methodologies are disclosed where an infrastructure is supplied to enable usage of the disclosed methodology. In an embodiment, application programming interfaces (API) are provided to handle the details where examples are available on the 0chain platform. For this disclosure, high level descriptions of the details are discussed which should be adequate for those with ordinary skill in the art to implement solutions. In this disclosure, support for the identified features may be identified as modules in the blockchain platform with embodiments as described herein embedded in the modules.

The following definitions generally apply to this disclosure and should be understood in both the context of client/server computing generally, as well as the environment of a blockchain network. These definitions, and other terms used herein, should also be understood in the context of leading white papers pertaining to the subject matter. These include, but are not necessarily limited to, Bitcoin: A Peer-to-Peer Electronic Cash System (Satoshi Nakamoto 2008). It will be understood by a person of ordinary skill in the art that the precise vocabulary of blockchains is not entirely settled, and although the industry has established a general shared understanding of the meaning of the terms, reasonable variations may exist.

The term “network” generally refers to a voice, data, or other telecommunications network over which computers communicate with each other. The term “server” generally refers to a computer providing a service over a network, and a “client” generally refers to a computer accessing or using a service provided by a server over a network. The terms “server” and “client” may refer to hardware, software, and/or a combination of hardware and software, depending on context. The terms “server” and “client” may refer to endpoints of a network communication or network connection, including but not necessarily limited to a network socket connection. A “server” may comprise a plurality of software and/or hardware servers delivering a service or set of services. The term “host” may, in noun form, refer to an endpoint of a network communication or network (e.g., “a remote host”), or may, in verb form, refer to a server providing a service over a network (“hosts a website”), or an access point for a service over a network. It should be noted that the term “blockchain network” as used herein usually means the collection of nodes interacting via a particular blockchain protocol and ruleset. Network nodes are the physical pieces that make up a network. They usually include any device that both receives and then communicates information. But they might receive and store the data, relay the information elsewhere, or create and send data instead.

The term “asset” means anything that can be owned or controlled to produce value.

The term “asymmetric key encryption,” also known as “public key encryption,” “public key cryptography,” and “asymmetric cryptography,” means a cryptographic system that uses pairs of mathematically related keys, one public and one private, to authenticate messages. The “private key” is kept secret by the sending of a message or document and used to encrypt the message or document. The “public key” is shared with the public and can be used to decrypt the message or document.

The term “ledger” means the append-only records stored in a blockchain. The records are immutable and may hold any type of information, including financial records and software instructions.

The term “blockchain” means a distributed database system comprising a continuously growing list of ordered records (“blocks”) shared across a network. In a typical embodiment, the blockchain functions as a shared transaction ledger.

The term “transaction” means an asset transfer onto or off of the ledger represented by the blockchain, or a logically equivalent addition to or deletion from the ledger.

The term “blockchain network” means the collection of nodes interacting via a particular blockchain protocol and rule set.

The term “nonce” means an arbitrary number or other data used once and only once in a cryptographic operation. A nonce is often, but not necessarily, a random or pseudorandom number. In some embodiments, a nonce will be chosen to be an incrementing number or time stamp which is used to prevent replay attacks.

The term “block” means a record in a continuously growing list of ordered records that comprise a blockchain. In an embodiment, a block comprises a collection of confirmed and validated transactions, plus a nonce.

The term “hash” means a cryptographic algorithm to produce a unique or effectively unique value, properly known as a “digest” but sometimes informally referred to itself as a “hash,” usually from an arbitrary, variable-sized input. Hashes are repeatable and unidirectional, meaning the algorithm always produces the same digest from the same input, but the original input cannot be determined from the digest. A change to even one byte of the input generally results in a very different digest, obscuring the relationship between the original content and the digest. SHA256 (secure hash algorithm) is an example of a widely used hash.

The term “mining” means the process by which new transactions to add to the blockchain are verified by solving a cryptographic puzzle. In a proof-of-work blockchain network, mining involves collecting transactions reported to the blockchain network into a “block,” adding a nonce to the block, then hashing the block. If the resulting digest complies with the verification condition for the blockchain system (i.e., difficulty), then the block is the next block in the blockchain.

The term “miner” refers to a computing system that processes transactions. Miners may process transactions by combining requests into blocks. In embodiments, a miner has a limited time, for example, 15-50 milliseconds, to produce a block. Not all miners generate blocks. Miners that generate blocks are called “generators.” Miners may be ranked and chosen to perform transactions based on their ranking. Some limited number of miners may be chosen to perform validation. All miners must be registered on the blockchain. The mining process involves identifying a block that, when hashed twice with SHA256 yields a number smaller than the given difficulty target. While the average work required increases in inverse proportion to the difficulty target, a hash can always be verified by executing a single round of double SHA-256. For the bitcoin timestamp network, a valid proof-of-work is found by incrementing a nonce until a value is found that gives the block's hash the required number of leading zero bits. Once the hashing has produced a valid result, the block cannot be changed without redoing the work. As later blocks are chained after it, the work to change the block would include redoing the work for each subsequent block. Majority consensus is represented by the longest chain, which required the greatest amount of effort to produce. If a majority of computing power is controlled by honest nodes, the honest chain will grow fastest and outpace any competing chains. To modify a past block, an attacker would have to redo the proof-of-work of that block and all blocks after it and then surpass the work of the honest nodes. The probability of a slower attacker catching up diminishes exponentially as subsequent blocks are added.

Messages representing generated blocks are sent to all miners by identifying the block with a block hash, transaction hash, and a signature of the minor producing the block. The miners receiving the messages replay the transactions for the block and sign an authentication message. If there are enough miners authenticating the block, a consensus ticket is signed. In some embodiments a 2/3+1 agreement or 67% agreement is needed to generate the consensus ticket.

The term “sharding” is a technique in blockchain that seeks to achieve scalability within a blockchain network. The process of sharding seeks to split a blockchain network into separate shards, that contain their own data, separate from other shards.

The term “sharder” refers to a computing system that that keeps tracks of its blockchain history. They are a single source of truth regarding any given transaction.

The term “transaction fee” means a fee imposed on some transactions in a blockchain network. The amount of the transaction fee is awarded to the miner who successfully mines the next block containing that transaction.

The term “wallet” means a computer file or software of a user that allows a user of a blockchain network to store and spend cryptocurrency by submitting transactions to the blockchain network. A wallet is usually itself protected by cryptography via a private key.

The term “consensus” refers to a computational agreement among nodes in a blockchain network as to the content and order of blocks in the blockchain.

The term “digital signature” means a mathematically-based system for demonstrating the authenticity of a message or document by ensuring that it was sent from the identified sender and not tampered with by an intermediary. Blockchains generally use asymmetric key encryption to implement digital signatures. Messages exchanged over the internet or a network in and itself do not have information as to the source and the recipient does not know whether to trust such a message or not. Digital signatures are a standard element to ensure that the message is sent by the person who says he sent it, was not changed during the transmission and the person cannot later deny having sent that message.

The term “fork” means a split in a blockchain where two different valid successor blocks have been mined and are present in the blockchain, but consensus has not yet been reached as to which fork is correct. This type of fork is also referred to as a “soft fork,” and is automatically resolved by consensus over time. A “hard fork” is the forced imposition of a fork by manual intervention to invalidate prior blocks/transactions, typically via a change to the blockchain rules and protocol.

The term “cryptocurrency” (or “crypto”) is a digital currency that can be used to buy goods and services but uses an online ledger with strong cryptography to secure online transactions. Much of the interest in these unregulated currencies is to trade for profit, with speculators at times driving prices skyward. There are currently many different types of cryptocurrencies offered by many different blockchain implementations. The usage of any given cryptocurrency may be represented herein as “tokens.”

The term “genesis block” means the very first block in a blockchain, that is, the root of the Merkle tree.

The term “proof-of-stake” means a mining system in which the production and verification of a block is pseudo-randomly awarded to a candidate miner, or prioritized list of candidate miners, who have invested a valuable stake in the system which can be collected by the blockchain network if the produced block is later deemed invalid. The stake functions as a deterrent against fraudulent blocks.

The term “proof-of-work” means a mining system in which the difficulty of finding a nonce that solves the cryptographic puzzle is high enough that the existence of a block compliant with the verification rules is itself sufficient proof that the block is not fraudulent.

The term “smart contracts” means computer programs executed by a computer system that facilitate, verify, or enforce the negotiation and performance of an agreement using computer language rather than legal terminology. Smart contracts may be verified and executed on virtual computer systems distributed across a blockchain.

The terms “web,” “web site,” “web server,” “web client,” and “web browser” refer generally to computers programmed to communicate over a network using the Hypertext Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

The terms “erasure code” or EC is a forward error correction (FEC) code under the assumption of bit erasures (rather than bit errors), which transforms a message of k symbols into a longer message (code word) with n symbols such that the original message can be recovered from a subset of the n symbols. The fraction r=k/n is called the code rate, referenced as (k, n) EC.

The term “database” means a computer-accessible, organized collection of data, which may be referred to as “content” in this document. Databases have been used for decades to format, store, access, organize, and search data. Traditionally, databases were stored on a single storage medium controlled by a single computer processor, such as a fixed disk or disk array. However, databases may also be organized in a “distributed” fashion, wherein the database is stored on a plurality of storage devices, not all of which are necessarily operated by a common processor. Instead, distributed databases may be stored in multiple component parts, in whole or part, dispersed across a network of interconnected computers. “Difficulty” means proof-of-work mining, or the expected total computational effort necessary to verify the next block in a blockchain. Difficulty is generally determined by the verification rules of the blockchain and may be adjusted over time to cause the blockchain to grow (e.g., new blocks to be verified and added) at a desired rate. For example, in the Bitcoin blockchain network, the difficulty adjusts to maintain a block verification time of about ten minutes across the blockchain network.

It will be understood by one of ordinary skill in the art that common parlance in the computing industry refers to a “user” accessing a “site.” This usage is intended to represent technical access to an online server by a user via a user computer. That is, the reference to a “user” accessing a “server” refers to the user manipulating or otherwise causing client software to communicate over a telecommunications network with server software. This also typically means that the user's client software is running on a client computer system and accessing the server computer system remotely. Although it is possible that a user may directly access and use the server via the server hardware, and without use of a client system, this is not the typical use case in a client/server architecture.

The systems and methods described herein enable a user in a rewards or points-based system implemented via a blockchain network, to purchase a content according to terms of a smart contracts. Users can receive, store, and share or send rewards on-demand in exchange for receiving the content. However, the user need not directly use, or even be aware of, the underlying blockchain.

Described herein are systems and methods for an on-line, verifiable payment system that facilitates both manual and automatic payment with transaction costs as small as fractions of a cent. The systems and methods include a financial accounting system that uses smart contract technology and a centralized authority performing blockchain transactions on behalf of multiple independent users and using bulk processing of transactions to reduce substantially the associated transaction fees, in some cases to fractions of a penny.

One key distinction of the disclosed data storage system from other blockchain storage solutions is the separation of the role of mining from that of providing storage. Computers that provide storage are referred to as blobbers. Blobbers are neither responsible nor required to perform mining. In this manner, the load is lightened on the mining network and enables fast transactions on a lightweight blockchain. As the client and blobber interact, the client generates special signed receipts called markers. These markers act like checks that the blobber can later cash in with the blockchain.

Once the interaction between client and blobber has concluded, the blobber writes an additional transaction to the blockchain, which redeems the markers for tokens, that is, the platform cryptocurrency, and commits the blobber to a Merkle root matching the data stored. The leaves of the Merkle tree must match markers sent from the client, preventing either the client or the blobber from defrauding each other.

After a file has been stored, a challenge protocol ensures both that the blobber continues to store the file and continues to be paid for that work. The mining network posts a transaction, challenging the blobber to prove that it still possesses the data that it was paid to store. The blobber must provide that data, the relevant system metadata, and the client-signed marker to prove that the right data is stored. The blobber is then rewarded or punished accordingly.

With the disclosed design, the majority of the work between clients and blobbers happens off-chain. The mining network is only involved enough to ensure that clients pay blobbers for their work and that the blobbers are doing the work that they have been paid to do. This approach assumes that the client is using erasure codes to ensure greater resiliency. While this is not a strict requirement, it does enable a client to recover if a blobber proves to be unreliable.

In broad embodiment, the invention is systems and methods of a blockchain platform for intermediaries to provide different services including proxy re-encryption, independent audit services, multi-sig smart wallet and split-key based passwordless login.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures.

The above-described functions and components may be comprised of instructions that are stored on a storage medium such as a computer readable medium. The instructions may be retrieved and executed by a processor. Some examples of instructions are software, program code, and firmware. Some examples of storage medium are memory devices, tapes, disks, integrated circuits, and servers. The instructions are operational when executed by the processor to direct the processor to operate in accord with some embodiments. Those skilled in the art are familiar with instructions, processor(s), and storage medium.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

A detailed description of one or more implementations of the invention is provided here along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

One of the major concerns related to the blockchain technology is scalability and in general efficiency/reliability of the whole operation. For instance, every user in this community, sooner or later, directly or indirectly, is forced to deal with challenges of maintaining and managing the cryptographic keys that are used. The subtleties and challenges involved in key generation, maintenance and management are well known in security industry and both cryptographic and policy based solutions have been devised in the past. However, in the context of cryptocurrencies, there are no satisfactory solutions that would help scalability or ease of use. The second major concern is related to computational efficiency of the tasks performed during the execution of the protocols. One of the most computationally intense and most frequently used cryptographic primitives in blockchain technology is digital signatures. The users need to generate every transaction with appropriate authentication done on the transaction and the miners or validators need to verify/validate the same multiple number of times.

In order to handle the challenges and complexities of key management, a number of techniques were proposed and deployed in different cryptocurrencies. In Bitcoin core, the keys are maintained in local storage. A typical user has access to a wallet software and uses the wallet to authenticate transactions being generating. As wallets generate the digital signature, the wallet requires an access to the private key of the user. While this speeds up the wallet operations, the presence of a key for a long time in a system that is online increases its vulnerability. Off-line storage and air gapped storages may be used. Password protected wallets are deployed by certain systems but they do not provide any security against a malware that might read the key strokes etc. Third party hosted wallets are also suggested to remove the pains of key management to a novice user but that usage requires enormous amount of trust in a third party.

In view of the shortcomings of the existing systems, a simple, easy to implement, secure approach to key generation that offers protections against theft/loss of the systems is disclosed. Given that a typical user may have several devices (at least two, say a laptop and a mobile phone/notepad), the “the private key” is split into several components with each component stored on each device. The objective is to have adequate protection: 1) In the case of a loss or corruption of a component of a key. 2) In the case of loss/theft of the device and subsequent abuse of the key component available in the device. 3) Signature generation must involve all the split components. 4) The individual components of the signatures generated in each device is secure on its own and does not lead to any attacks and key exposure.

The (BLS) short signature scheme of Boneh, Lynn and Shacham is quite amenable for such split-ups in which an effective split-up be achieved. Such split-up is not possible in Schnorr signature or Elliptic Curve Digital Signature Algorithm (ECDSA) without sharing information between the two devices that generate the partial signatures.

The transaction generation as well as the block formation/validation involve running computationally intense signing and verification algorithms. Typically, the block size is kept small by design in order to speed up the communication and in small blocks, it is observed that signatures occupy a significant amount of space. For example, it is estimated that nearly 40% of the transcript space is occupied by signatures in case of bitcoin. The computations involved in some of the deployed signature schemes are found to be very complex. For instance, the most widely used Elliptic Curve Digital Signature Algorithm (ECDSA) combines the long term and short term keys in a non-linear fashion and that directly contributes to its inefficiency. Moreover, each block formation calls for verification of a number of signatures (the signatures found in the transactions chosen for pooling) and when the block is broadcast, again the validation process calls for huge number of signature verifications at every node of the network. In this context, aggregate verification offers an efficient solution. In signature aggregation/verification, several signatures are combined into one “super” signature and verification is only performed on the super signature rather than on the individual signature. This leads to a dramatic drop in the verification cost of n signatures to the cost of verifying one signature. This clearly saves space and a significant amount of computing time. In an embodiment, the aggregation of the signatures may be done by the miners generating the block (generator), so that the miners doing the verification (verifier) doesn't have to verify each signature but just verifies the aggregate block signature to reduce compute time.

TABLE 1
Split-key algorithm

| BLS Keys | Device 1 | Device 2 |
|---|---|---|
| Private Key: x ∈ Z^{q} | Accept mnemonic₁ | Accept Passcode |
| Private Key: X = xP | x₁ = H₁(mnemonic₁) | s₁ = x₂ − H₁ (Passcode) |
| σ = xH(m) | x₂ = x − x₁ | Store s₁ |
| | Store x₁ and x₂P | |
| | Send x₂ to device 2 | |

TABLE 2
Signing Workflow

| Device 2 | Device 1 |
|---|---|
| Accept Passcode | Check if ê(σ₂, P) [symbol] ê (H(m), x₂P) |
| x₂ = s₁ + H₁ (Passcode) | σ = x₁ H (m) + σ₂ = x₁H(m) + |
| σ₂ = x₂H(m) | x₂H(m) = xH(m) |
| Send σ₂ to device 1 | Output σ as the signature for m |

In an embodiment, the split-key wallet protocol uses a Boneh-Lynn-Shacham (BLS) signature scheme that is based on bi-linear pairings. A pairing, defined as e(,), is a bilinear map of 2 groups G1 and G2 in some other group, GT. e(,) takes e as arguments points in G1 and G2.

Pairings that verifies a signature have the form: e(g1, sig)=e(pk, H(m)) (in expanded form: e(g1, sk*H(m))=e(sk*g1, H(m)=e(g1, sk*H(m)) H(m) is hashing a message to a point on an elliptic curve.

BLS has:
KeyGen—choose a random a. Given generator g1, pk=a*g1
Sign—σ=a*H(m)ϵG2 (in the case of eth2.0)
Verify(pk,m, σ)—if e(g1, σ)=e(pk, H(m)) return true.

The BLS signature scheme may be used to split keys and let users interact using crypto keys via a blockchain. Since the cryptocurrency balance is maintained against these keys, it's very important to protect the private key. The private key may be split into two secondary keys, storing each of the secondary key on a different device. Signing requires individual signatures from each device. Hence, losing any one device can still protect the primary key. In addition, if desired, one of the secondary keys can be further split into two parts; only one of which is stored on the device and the other may be a simple PIN that the user has to enter each time. This provides an extra layer of protection in case both devices are compromised. In this scheme, it is easy to generate as many split keys as desired providing the ability for the user to periodically rotate the split keys and in the process change the PIN.

With cryptocurrency, some quantity of tokens may be locked. In an embodiment, support may be provided for selling the cryptocurrency by specifying a name for locks, keys to the locks, how long each key is valid (from seconds to centuries), a number of keys, a price of the keys. Tokens acquired may be “locked” for the time each key is valid.

The actual verification is done by a group of machines called the validators. The validators can be any group of machines, depending on what makes sense in the blockchain ecosystem. Validators are mutually untrusting. In an embodiment, the validators may be a distinct group of machines from the miners and blobbers.

At a high level, the challenge protocol involves three phases: 1) The mining network randomly selects the blobber data allocation to be challenged. This process also specifies the validators who will verify the challenge and provides a random seed to be used for the challenges. This stage is referred to as the challenge issuance. 2) In the justification phase, the blobber broadcasts the data to the validators along with the metadata needed to verify the challenge. 3) Finally, in the judgment phase, the validators share their results. Once the validators have agreed on the results of the challenge, they write a transaction to the blockchain indicating whether the test passed. This transaction also pays the validators and rewards the blobber.

Selecting validators is a particular challenge. In a cronyism attack, a blobber sends the data to a friendly validator who approves all challenges without validating the data. In an extortion attack, a validator demands additional compensation from the blobber in exchange for passing the challenge.

These attacks are avoided by having the mining network randomly select a set of validators. For a challenge to pass, at least N validators must approve the results of the challenge. The difference between these values must be narrow enough to make a successful cronyism attack unlikely, but high enough to prevent an extortion attack. An additional concern is that the validators actually do the verification work. A validator who does not do the work but who attempts to collect the reward is called a freeloader.

Challenge Issuance Phase: The mining network must initially post a transaction to the network by randomly challenging a blobber providing storage. This challenge issuance transaction may include: 1) The allocation of data challenged, identified by allocation_id. Note that this should implicitly identify which blobber is challenged. 2) The list of eligible validators. 3) A random seed, which determines the indices of the data blocks in that allocation that the blobber must provide. 4) The latest write marker at the time of the challenge. Conceptually, this challenge issuance transaction is comparable to a roulette wheel, where the number of tokens currently due to the blobber from its challenge pool dictates its number of slices on the wheel. An alternate approach would be to use the size of the data allocation instead, but this can lead to a subtle attack. A blobber could post an agreement for a negligible price with itself as the client, and then commit to storing large amounts of easily regenerated data. With a commitment to a large enough amount of data, other blobbers would be challenged only with a low probability. By tying the probability of being challenged to the amount of tokens in the challenge pool, this attack becomes prohibitively expensive to carry out. The initial transaction essentially locks a portion of the blobber's stake and reward in a sub-pool specific to this challenge. A “guilty until proven innocent” approach is used to prevents a blobber from attempting a denial-of-service attack against a validator in order to avoid punishment. If the blobber never satisfies the challenge, the tokens are effectively burned.

Justification Phase: When the blobber observes the challenge issuance on the blockchain, it broadcasts its proof of storage to the validators with: The file system metadata. The write marker proving that file system contents match what is stored on the blockchain. The challenged blocks of data are chosen pseudo randomly using the miner's random seed and the Merkle paths of those data blocks.

Once the validators receive the blobber's data, they each verify the data that they have been sent. The validator verifies that: The file system metadata is valid. The file system root hash matches the write marker. The write marker matches the most recent commitment to the blockchain. At this point, the validator has established that the blobber's metadata is valid and matches the blockchain. The validator then calculates the number of blocks on the system from the allocation size. Using the random seed, the validator verifies that the blobber's blocks correspond with the pseudorandom sequence. (This serves to make every block of data on the system equally likely to be challenged, and ensures that the blobber did not try to game the results).

For each data block, the blobber verifies that the Merkle path matches up to the file metadata. As part of this process, the validator stores the two penultimate hashes of the Merkle tree; that is, it stores the two hashes that can be hashed together to give the file's Merkle root. These two hashes are called the validation proof.

At most one of the hashes in the validation proof should have been provided by the blobber. (To ensure this behavior, the inclusion of additional hashes on the Merkle path is an autornatic failure.) Therefore, the validator must have done the work to calculate at least one of the two hashes. This validation proof can be verified easily by the other validators. These proofs are an important part of the disclosed defense against freeloaders.

Judgment Phase: After the validator has completed its work, it broadcasts the signed hash of its results. This signed hash is called the pre-commit. The hash format is H=hash (validationProof List_R), where validation Proof List is a list of the hash pairs serving as validation proofs for each file, and R is a randomly chosen nonce selected by the validator.

The validator then waits to collect the pre-commits for the other validators. Once the timeout period has been reached, it broadcasts its validProof List and its R value to publish its results. No additional pre-commits are accepted at this point. (If less than the minimum number of required signatures is received, it will rebroadcast and wait again).

The validator accepts the signatures of all other validators with valid proofs. provided that the other validators submitted valid pre-commits. Since the results are not publicly observable until after the results are completed, a freeloader is not able to provide a valid pre-commit. Each validator submits a transaction to the blockchain with its results. The smart contract accepts the first transaction it receives, and only the first. At this point, the blobber receives its reward and the validators receive payment for their work. The payout amount is pro-rated to match the total payout and the length of the contract. For instance, if blobber Bob's challenge pool contains 12 tokens from Alice for storage paid over a contract period of 90 days, and the first challenge happens at day 45, Bob receives 6 tokens for passing the challenge. If Bob is again challenged at day 60, Bob receives an additional 2 tokens. On day 90, Bob receives the remaining balance of 4 tokens.

The validators are paid in a pro-rated manner like the blobber is rewarded. An equal portion of the reward is set aside for every validator, even those that did not participate in the validation. However, the rewards are only distributed to validators who participated in the validation process; the reward for non-participating validators is burned. This design ensures that validators have no incentive to exclude each other; instead validators have a strong incentive to perform the validation work.

The BLS signature scheme may be used to split keys and let users interact using crypto keys via a blockchain. Since the cryptocurrency balance is maintained against these keys, it's very important to protect the private key. The private key is split into two secondary keys, storing each of the secondary key on a different device. Signing requires individual signatures from each device. Hence, losing any one device can still protect the primary key. In addition, if desired, one of the secondary keys can be further split into two parts; only one of which is stored on the device and the other may be a simple PIN that the user has to enter each time. This provides an extra layer of protection in case both devices are compromised. The split-key wallet protocol makes it easy to generate as many split keys as desired providing the ability for the user to periodically rotate the split keys and in the process change the PIN.

With cryptocurrency, some quantity of tokens may be locked. In an embodiment, support may be provided for selling the cryptocurrency by specifying a name for locks, keys to the locks, how long each key is valid (from seconds to centuries), a number of keys, a price of the keys. Tokens acquired may be “locked” for the time each key is valid.

When clients lock tokens, they are rewarded with an “interest.” The interest is newly generated crypto-currency tokens, intended (but not required) for payment of services on the network. These services can be miner compensation for transaction processing, blobber compensation for storage, or transmitted to any other client in exchange for a service; facilitating a lucrative market for building and running distributed applications. In the event of network congestion, a client may also offer to lock a greater number of tokens to ensure that their transaction is accepted by the mining network. The token reward protocol creates an economy where the tokens can be used to receive services for “free”—meaning, the client does not lose their initial stake, but still adequately compensates the service provider.

The systems and methods of a blockchain platform for distributed applications includes separation of roles for a miner and a blobber. The message flow model between different parties including a client, a blobber and a miner allows for fast transactions on a lightweight blockchain by lightening the load on a mining network, i.e. a network of one or more miners. Offloading the work to a different group of machines allows for greater specialization in the design and specifications of the machines, allowing for the blockchain platform miners to be optimized for fast transaction handling and blockchain platform blobbers to be efficient at handling data for given transaction types.

In one embodiment, the distributed application is a storage application. Users of the system can request and get storage access without relying on a single source. While the distributed application described herein in detail is a storage application, a person of ordinary skill in the art would understand and apply the same invention disclosure on different types of distributed applications. The use of a distributed storage application is exemplary and not limiting in anyways the scope of the invention.

In one embodiment, a storage protocol applied on the blockchain platform relies on the miners to serve as intermediaries in all storage transactions. Furthermore, the blockchain platform may enforce strict requirements on blobbers and blobbers' machines to ensure a fast and lightweight response time and execution.

In one embodiment, data integrity of the transaction is verified by using hash of a file's contents. In another embodiment, the data is fragmented in two or more parts and each data part is separately hashed to create a Merkle tree. In one embodiment, the entire Merkle tree is stored and probabilistically verified. In another embodiment, the miners store the Merkle root of the stored files.

The role-based distributed execution using a message flow model on a blockchain platform allows for a flexible and robust model with feedback and evaluation of different parties based on past interactions. For example, the blockchain platform involves interaction between two or more clients, who have data that they wish to store, and blobbers who are willing to store that data for a fee. Neither the client nor the blobber necessarily trust one another, so transactions are posted to a blockchain produced by a trusted network of miners, i.e., a trusted mining network.

Players. The blockchain platform using a message flow model for role-based distributed work seeks to minimize the load on the mining network, so miners are not directly involved in the file transfer between clients and blobbers. Nonetheless, the transactions posted to the blockchain assures clients that their data is stored and gives blobbers confidence that they will be paid for their service; if either party misbehaves, the blockchain platform has the information to help identify cheaters.

Each client includes an application responsible for encrypting the data. The blockchain platform relies on erasure coding, which is also performed by the client. Clients are assumed to have a public/private key pair and a certain number of tokens. Erasure coding is a method of data protection in which data is broken into fragments, expanded and encoded with redundant data pieces and stored across a set of different locations or storage media. A miner works on a central chain of the blockchain platform. For example, in the context of storage, miners are responsible for accepting requests from clients, assigning storage to blobbers, locking client tokens to pay for their storage, and testing that blobbers are actually providing the storage that they claim. A blobber is responsible for providing long-term storage. Blobbers only accept requests that have been approved by the mining network, which helps to prevent certain attacks. Blobbers are paid in three ways: (i) When data is read from them, the clients give them special markers that the blobber can redeem for tokens; (ii) When client writes data to them, blobbers get special markers; and (iii) whenever a blobber is storing data, they are randomly challenged to provide special blocks and if these challenges are passed, the mining network rewards the blobber with tokens.

Protocol Sketch. For example, one basic message flow model based on roles on a blockchain platform for a distributed storage application can be broken into five parts. First, clients must use tokens to reserve system resources. These resources include the amount of storage, the number of reads, and the number of writes needed for the data. The client's tokens are locked for a set period of time. Once the time has elapsed, the client regains their tokens and loses their storage resources. Of course, a client may decide to re-lock their tokens to maintain their resources, though the number of tokens needed may change depending on the economy.

When clients want to use the resources that they have purchased, they must write a transaction to the network declaring their intent. The mining network connects the clients with the appropriate blobbers and allows them to set up a secure connection.

Once the connection is established, the mining network no longer acts as an intermediary between the client and the blobbers. During this phase, the client generates markers to give to the blobber in exchange for access to system resources. The blobber collects these markers and redeems them with the mining network once the transaction is complete; this transaction also notifies the blobber that the transaction has finished, and lets the network know that the miner and blobber agree on the data that the blobber is expected to store. In one embodiment, the markers help resolve disputes in case the client and blobber do not agree on the Merkle root.

After the blobber has completed the transaction, the mining network will periodically challenge the blobber to provide a randomly chosen block of data. These challenges involve a carrot and stick approach; blobbers are punished if they fail the challenge, and blobbers are rewarded with additional tokens when they pass the challenge. The blockchain platform ensures that blobbers are paid even when the data is not frequently accessed. When the client no longer wishes to store a file, they issue a deletion transaction to the network. Once it is finalized, blobbers delete the file and clients may use their storage allocation to store other files.

Error and Repair. One or more error reporting protocols and/or repair protocols work with the basic message flow model based on roles on a blockchain platform for a distributed storage application. In one embodiment, the error reporting protocol allows both clients and blobbers to report problems to the network. These problems could include either reports of when other clients or blobbers are acting maliciously, or when a system fails or drops from the network unexpectedly.

In one embodiment, a repair protocol arises when a blobber is identified as malicious, drops from the network, or is no longer considered suitable for storing the data that it has. When needed, the client can read the data from the network, reconstruct the missing fragment of data, and re-upload it to the network. In one embodiment, the mining network reconstructs a missing slice of the data from any other available slices without involving the client.

Attacks. The message flow model for the blockchain platform is robust and resilient to different types of attacks. For example, an outsourcing attack arises when a blobber claims to store data without actually doing so. The attacker's goal in this case is to be paid for providing more storage than is actually available. For example, if Alice is a blobber paid to store filel23, but she knows that Bob is also storing that file, she might simply forward any file requests she receives to Bob. The blockchain platform defense against this attack is to require all data requests to go through the mining network. Since the cheater must pay the other blobbers for the data, this attack is not profitable for the cheater. Additionally, the mining network's blockchain gives some accounting information that can be analyzed to identify potential cheaters.

A Sybil attack is a kind of security threat on an online system where one person tries to take over the network by creating multiple accounts, nodes or computers. This can be as simple as one person creating multiple social media accounts. But in the world of cryptocurrencies, a more relevant example is where somebody runs multiple nodes on a blockchain network.

Another attack may occur if two blobbers collude, both claiming to store a copy of the same file. For example, Alice and Bob might both be paid to store filel23 and file456. However, Alice might offer to store filel23 and provide it to Bob on request, as long as Bob provides her with file456. In this manner, they may free up storage to make additional tokens. In essence, collusion attacks are outsourcing attacks that happen using back-channels. A Sybil attack in the context of storage is a form of collusion attack where Alice pretends to be both herself and Bob. The concerns are similar, but the friction in coordinating multiple partners goes away. The blockchain platform message flow-based model requires that the blobbers are assigned randomly for each transaction, helping to further reduce the chance of collusion.

The blockchain platform uses erasure codes to help defend against unreliable blobbers in a network. Furthermore, the blockchain platform makes demands on the capabilities of blobbers authorized to use the platform. For example, if it repeatedly underperforms expectations, a blobber's reputation may suffer, and risk being dropped from the network.

In another attack, a client might attempt to double-spend their tokens to acquire additional resources. However, the client is not given access to its resources until the transaction has been finalized. The blockchain platform transactions are designed for rapid finalization, so the delay for the client should be minimal. Other attacks such as fraudulent transactions are the purview of the mining protocol and the blockchain platform is well designed with defenses based on its robust implementations of authentication and data integrity modules. A replay attack also fails on the blockchain platform with the use of timestamps as one of the fields to assign unique transaction id.

Finally, generation attacks may arise if a blobber poses as a client to store data that they know will never be requested. By doing so, they hoped to be paid for storing this data without actually needing the resources to do so. The blockchain platform can defend against generation attacks with a challenge protocol that requires blobbers to periodically provide files that they store.

Locking System Resources. The message flow model for the blockchain platform is robust and resilient in locking system resources and reusing the same when resources are freed. For example, in order to store files, clients must use their tokens to purchase a certain amount of storage for a year. During this period, the clients' tokens are locked and cannot be sold. Likewise, to access or update their data, clients must purchase a certain number of reads and writes. To lock tokens, the client posts a transaction to the mining network. For example, the transaction includes the following without limitations: (i) the id of the client (client_id); (ii) the amount of storage (amt_storage); (iii) the number of reads (num_reads); (iv) the number of writes (num_writes); (v) a params field for any additional requirements allowing for flexibility. Only one of amt_storage, num_reads, and num_writes is required since a client may be locking additional resources to supplement a previous transaction. However, the blockchain platform generally expects a client to lock all three in any transaction.

A person of ordinary skill in the art would understand that there are well-established methods and techniques to establish a secure digital connection between any two parties on the internet. The blockchain platform relies on the well-established methods to establish a secure connection with an added layer of security based on the role of the party i.e. the role of a client, a blobber or a miner. Neither the client nor the blobber trust one another, yet the blockchain platform allows both parties acting in its own best interest to nonetheless benefit each other. Any transgressions can be identified by the mining network of the blockchain platform with one or miners having the authority to punish any misbehaving party.

Creating a Connection. In establishing a connection, the blockchain platform performs the following: (i) assign blobbers to handle a client's request; and (ii) to ensure that the mining network knows what data the client wishes to store, allowing the network to police the client's and blobber's behavior. In one embodiment, the client and the blobber establish a session key between themselves. In another embodiment, the client and blobber set up a Transport Layer Security (TLS) connection instead of a session key.

A possible attack when creating a connection may include that a client might create a transaction on the mining network, but never send the data to the blobber, either as an attempt to damage a blobber's reputation or to prevent a blobber from being paid by other clients. On the blockchain platform, three factors mitigate this attack: (1) The client had to lock up tokens to perform this attack. In essence, they would be paying for storage without using it. (2) Blobbers are not challenged by the mining network until they post a transaction to finalize the data exchange. (3) Blobbers periodically monitor the blockchain for transactions involving them; if they notice this transaction, they can cancel it using an error reporting protocol.

Similarly, a blobber might not respond to the client and refuse to complete the connection. Again, several factors make this attack unlikely: (1) Once the connection is established, the client is expected to send markers. The blobber redeems these markers for tokens, and hence has a vested interest in completing the connection. (2) If the transaction times out, the client can report an error. (3) If the client becomes dissatisfied, they can delete their data from the blobber and reassign it to a different blobber. When this happens, the blobber is no longer paid for storing the data.

Reads and writes. After establishing a secure connection as described above, the blockchain platform performs reads and writes as described herein. Once a secure connection has been established between the client and the blobber, the client can choose to either read data from the blobber or update data stored with the blobber. The blockchain platform for uploading or downloading files requires that the client compensate the blobber. This process is done through the use of special read_marker and write_marker values created by the client. Each marker is a pair of a number (i) and a signature, where “i” is a counter starting at 0 that is incremented with each marker sent. READ and WRITE are constants included in the signatures denoting whether this is a read_marker or write_marker respectively.

The format of a read_marker is [READ, trans_id, blobber_id, block_num, client_id. The format of a write_marker is [WRITE, trans_id, blobber_id, hash(data), block_num, client_id, where hash(data) is the hash of the current block of data being sent. The blobber collects these markers, and when the transaction has either completed or timed out, the blobber writes a transaction to the blockchain effectively cashing in the markers in exchange for tokens. This transaction has the following effects: (i) The blobber is paid in tokens. (ii) The client loses the corresponding number of reads and writes. (iii) The Merkle root of the data (if it has been updated) is confirmed by the blobber. At this point, the blobber may be challenged to provide the data that they store. Since the blobber is also compensated for passing these challenges, they have a vested interest in completing the operation. Note that future transactions only allow access to the data if there is no discrepancy between the client and the blobber on the Merkle root of the data.

The information stored in the params field in message 1 depends upon the nature of the transaction. If this is a new file storage request, the k and n values for erasure coding must be included since these settings affect the behavior of the network during challenges. Also, if this is a new file upload or a file update, the client must include the file size, the version number of the file, the fragment_id, chosen by the client, for this fragment of the erasure coded data.

Markers may serve as additional authorization tokens, and hence the double-spending problem is a concern. Blobbers might attempt to redeem a marker multiple times, or a client might attempt to pay different blobbers with the same marker. Each trans_id uniquely identifies the file involved, and the mining network does not accept markers if the trans_id does not match an existing transaction for an open connection. When the blobber redeems the markers, the connection is considered closed, and so the blobber cannot reuse the markers in a future transaction. Each marker must be unique within the redemption transaction, so the blobber is not able to double spend the marker within the transaction either. A client might attempt to pay multiple blobbers with the same marker. However, since both trans_id and blobber_id are included in the marker, this attack would fail.

If blobbers pose as clients, it is possible that they could generate markers without reading the data solely as a mechanism to get tokens. However, since the blobber would have to lock tokens to acquire reads, it would in some sense be paying itself with its own tokens.

Clients might create more markers than the number of reads and writes they have purchased, essentially writing checks that they cannot cash. Clients are expected to track the number of markers that they have used, and therefore are the best ones to hold accountable. On the blockchain platform, if a client exceeds the number of markers that they are authorized to create, the blobber is still paid. However, instead of paying the blobbers in newly-minted tokens, they are paid in tokens taken from the client. Other type of attacks might include a blobber ignoring a client's request for data and simply cash the marker's sent by the client. However, in this case the client would quickly stop sending markers to the blobber, preventing the blobber from receiving additional payment. Furthermore, the client would report an error to the network, and might decide to delete their data from the blobber. The blobber might send invalid data; however, the client might have the Merkle tree, in which case they would quickly spot the problem and report an error. Regardless, the blobber is expected to store the Merkle tree and can asked to provide it. The mining network stores the Merkle root, preventing the blobber from providing a false tree.

In scenarios where a client simply writes data, the blobber might not store the data. However, when redeeming markers, the blobber must confirm the new Merkle root. Therefore, the mining network would be able to catch the blobber's cheating with the challenge protocol. In another scenario, a client might send different data to the blobber that does not match the Merkle root specified in the blockchain, either in a hope to damage the blobber's reputation or to frustrate the blobber by using its resources without paying it. The blobber cannot finalize the transaction, and therefore will not be challenged (and paid) for storing the data. However, the blobber can report the error to the mining network. Furthermore, every write_marker includes a hash of the block of data sent, which can serve as a form of proof about what data the blobber received from the client.

Deleting Files. To delete a file, the client posts a transaction to the blockchain deleting the resource. Once the transaction is finalized on the blockchain, the client regains the storage allocation.

Blobbers are expected to poll the blockchain for these transactions. Once they notice that a file has been deleted, all blobbers storing slices of this data delete its data. In some attacks, a client might attempt to get free storage by a distributed denial of service attack (DDoS) the blobbers before they receive the message to delete the data, but the mining network would not approve future read requests. Clients might attempt to delete data but maintain an open connection with blobbers. With this approach, the client would attempt to get free storage without needing to go through the mining network. A defense against this attack is that the mining network rejects all requests to delete data when there are open connections. If a blobber fails to close a connection, the client can report the error to the mining network and close the connection that way. Nothing on the blockchain platform enforces that the blobbers actually delete the data when asked though a blobber has little economic incentive to keep it. If the client is concerned about the confidentiality of its data, the client can encrypt its data before storage.

Challenge Request. In order to verify that a blobber is actually storing the data that they claim, the protocol relies on the miners periodically issuing challenge requests to the blobbers. The blockchain platform message flow model is also how blobbers are rewarded for storing files, even if the files are not accessed by any clients. When the blobber passes the challenge, it receives newly minted tokens. The mining network is responsible for establishing consensus on whether the blobber has passed the challenge. A transaction is posted by the mining network specifying which block of data is requested. The blobber sends the data to the mining network as well as the nodes of the Merkle tree needed to calculate the Merkle root. If the mining network reaches consensus that the blobber failed to provide the correct data in the allocated time, a transaction is posted punishing the blobber. Otherwise, a transaction is posted rewarding the blobber with the token. In one embodiment, an update to existing data may be canceled. The blobber might not have the correct data, and so cannot satisfy future challenges. Therefore, these cases are treated as delete transactions.

Recovering Data. There could be scenarios when the blockchain platform needs to recover data. When a blobber disappears unexpectedly from the network, or when a canceled transaction causes data to be lost, the data needs to be regenerated and stored with another blobber. In one embodiment, the repair operation is performed by the client, who will be required to get the needed slices, regenerate the new slice, and post a new transaction to store the regenerated slice. The cost of the transactions to recover the client's data is paid for by the client. However, if the loss is due to the misbehavior of a blobber, the blobber's stake may be seized and given to the client to help pay for the recovery.

If a client attempts to update data simultaneously with all blobbers, it is possible that all copies of the data could be deleted. In order to avoid this issue, the client can adjust the k and n values used in the erasure codes to provide greater resiliency and update the slices of data in sequence.

In one embodiment, the client must initially commit to the Merkle root of the data whenever a file is changed on the network. The result is that the transactions are either data writes or data reads. In one embodiment, the blockchain platform allows for reads and writes within a given client/blobber exchange. The client indicates the Merkle root is not yet known; when the blobber writes a transaction to cash their markers, they also commit to a Merkle root. The client can write a transaction on the blockchain either approving or contesting the Merkle root.

In one embodiment, the client can rebuild any data lost when a blobber goes offline unexpectedly. The client might not always be the best choice for this responsibility. If the client does not connect regularly, there might be a delay before they notice.

In one embodiment, when a blobber fails a challenge to provide a block of data, the mining network can initiate transactions to recover the missing fragment of data and reassign it to a different blobber. Any encryption by the client is performed before erasure coding to ensure that the data can be reconstructed without the client's aid.

Distributed Content Delivery Network. The blockchain platform using the message flow model can be used to geographically distribute data to increase the performance and availability of a client's data. A client may use encryption, distribute an application to reconstruct the data or use null encryption. The blockchain platform supports the ability for a client to stream content from a blobber.

On the blockchain platform, data blobs are identified by a combination of the client's unique id (client_id) and the client-chosen data_id. Individual transactions are assigned a trans_id based on the triple of these two fields and a timestamp (T). In addition to creating unique ids for transactions, the timestamp also ensures that each request is fresh and helps defend against replay attacks.

A proxy server acts as a gateway or an intermediary server separating end users from the websites they browse. Using a proxy server helps with controlling internet usage of employees and children, bandwidth savings, improved speeds, privacy benefits, improved security and access to blocked resources by pretending to be at another geographical location. Proxy Re-Encryption is a specialized cryptographic primitive that facilitates a user to share his encrypted file with another user without decrypting the file using a specialized key called Re-Encryption Key (ReKey). Proxy controls which ciphertext of the user needs to be translated or re-encrypted. There are no mechanisms known in the industry that allow flexible user control to proxy reencryption.

The current model of cloud storage is operated through centralized authorities, which makes such a system susceptible to single point failures and permanent loss of data. Blockchain technology, initially designed as a financial ledger has attracted the attention of researchers in a wide range of applications requiring accountable computing and auditability. Blockchain enabled distributed peer-to-peer cloud storage solutions are steadily replacing its centralized counterpart. A blockchain provides multiple parties to agree upon transactions and contracts in an immutable and auditable way. Decentralized application (dApp) providers make use of this capability to provide services that are transacted in a publicly verifiable manner. When the service provided by the dApp is not directly from the dApp owner itself but from other third parties, it brings up additional challenges. How would the end user using the dApp trust that the unknown third party service provides used by the dApp are trust worthy? The current approaches in the industry use a combination of unencrypted to cumbersome ways.

While there are policies in the industry that provide end-to-end user flexibility in securing content from authoring to distribution, none of them offer flexibility in a blockchain setup where there is no single entity on the cloud controlling access. While most systems offer securing content, they may fall short of providing an independently verifiable audit capability. In a world of increasing cyber crime and digital fraud, when something goes wrong, it requires a lot of time and effort to do digital forensic investigation. Blockchains can help reduce this burden by ensuring tamper-proof auditability is part of the enterprise workflows.

While there are means to enable shared smart contracts, a wallet is typically assigned to a single person or entity. For an entity hosting a smart wallet, there may be more than one person who has the access rights to make decisions of spending or buying on that smart wallet. In such a situation, the entity smart wallet authentication system is vulnerable if passwords are shared by two or more people. Such a vulnerability could also exist for a smart wallet associated with a household that has two or more members with access privileges.

Most of the existing and prevalent authentication methods rely on password-based authentication. Enterprises already use a single-sign on to make it easy for their employees to login to their various internal applications that each require login. Some require changing the password every few weeks or months. Some even prevent reusing the previous 10 passwords, making it extremely painful to employees. While this improves the security, it imposes unnecessary burden on the employees. There is no simple, seamless and effortless method to provide access without compromising on the level of security provided. With cybersecurity and privacy laws, enterprises have a higher need to provide a higher level security.

The systems and methods on a blockchain platform for intermediaries and passwordless login allow for intermediary proxy re-encryption, independent audits, secure multiple persons controlled smart contract or smart wallet, and split-keys short-range wireless device-based and passwordless client authentication. One or more entities (or service providers) that help or manage the self-regulation on the blockchain platform are miners. A client is an end-user with two or more computing devices who initiates the requests and wants to commit transactions on the blockchain platform. An intermediary may be a blobber or a sharder who uses a computing device that processes the applications on the blockchain platform.

Different embodiments described herein include components or structures to perform the described functionality. A “component” or a “module” as used in this invention disclosure, includes a dedicated or shared processor and, typically, firmware or software modules executed by the processor. Depending upon implementation-specific or other considerations, a module can be centralized or its functionality distributed. A component or a module can include special purpose hardware, firmware, or software embodied in a computer-readable medium for execution by the processor.

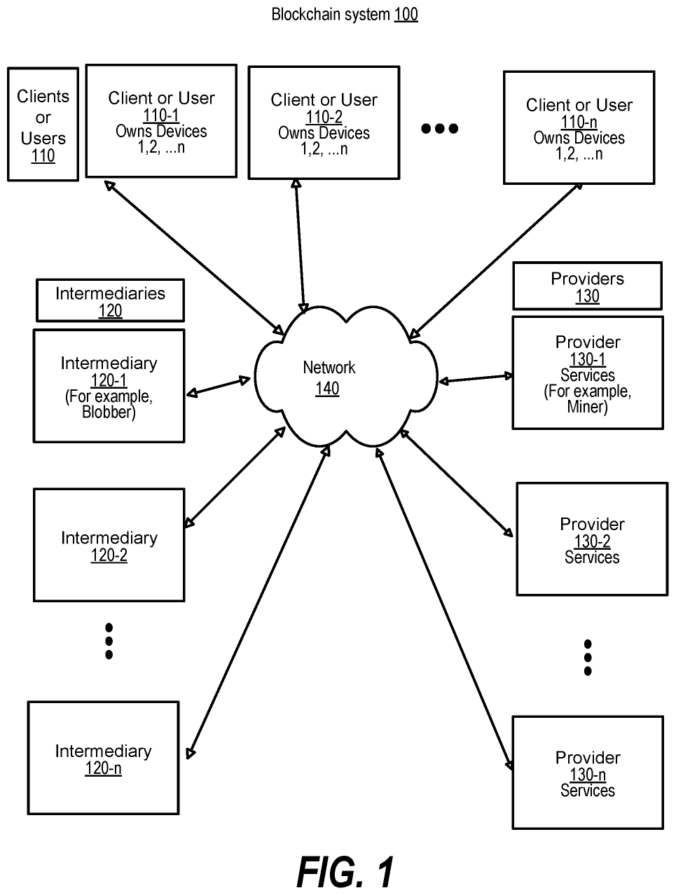

In one embodiment, FIG. 1 depicts a diagram 100 illustrating an example on a blockchain platform with intermediaries. In the example of FIG. 1, the environment includes consumers or client systems 110 representing a first consumer or client system 110-1, a 2^{nd} client system 110-2, . . . , through an nth client system 110-n wherein each client owns two or more devices 1, 2, 3, . . . n, connecting through network 140, a set of intermediary systems 120 representing intermediary system 120-1, a 2^{nd} intermediary system 120-2, . . . , through an nth intermediary system 120-n and a set of service providers 130 representing service provider 130-1, service provider 130-2, . . . , through an nth system 130-n. In an implementation, the client system 110 includes components related to requesting services from the blockchain platform. In one implementation, the client system 110 requests and uses a storage application for storage, read or write. The client may use a multiple signatures or group-based smart-contract or smart-wallet on the blockchain platform. The client may use passwordless authentication using split keys that are associated with two or more client devices. The client may request audit reporting for any of its transactions including storage read/write requests or adding/deleting of tokens from a smart contract or smart wallet.

The intermediary provides enforcement to parameters set with flexibility by a client including security policies on an encrypted file owned by a client. The intermediaries operate securely on the blockchain platform. The clients can delegate reencryption and use intermediaries as proxies. The intermediary can be providing proxy services, audit reporting server, enforcing multiple signatures on a smart contract or a smart wallet, provider of server-side passwordless authentication.

The service providers provide the underlying blockchain platform basic operations functionality. The blockchain platform may operate on a token-based transaction system. For example, in one embodiment, the service providers manage tokens when using a resource on the blockchain or when providing service.

Network 140 can be different wireless and wired networks available to connect different computer devices including client and server systems. In an implementation, network 140 is publicly accessible on the internet. In an implementation, network 140 is inside a secure corporate wide area network. In an implementation, network 140 allows connectivity of different systems and devices using a computer-readable medium. In an implementation, the blockchain platform allows users on the client system, the blobber, the sharder or the miner to have customized applications and operational framework.

The messaging and notification between different components can be implemented using application programming interface (API) calls, extensible markup language (“XML”) interfaces between different interfaces, Java/C++ object oriented programming or simple web-based tools. Different components may also implement authentication and encryption to keep the data and the requests secure.

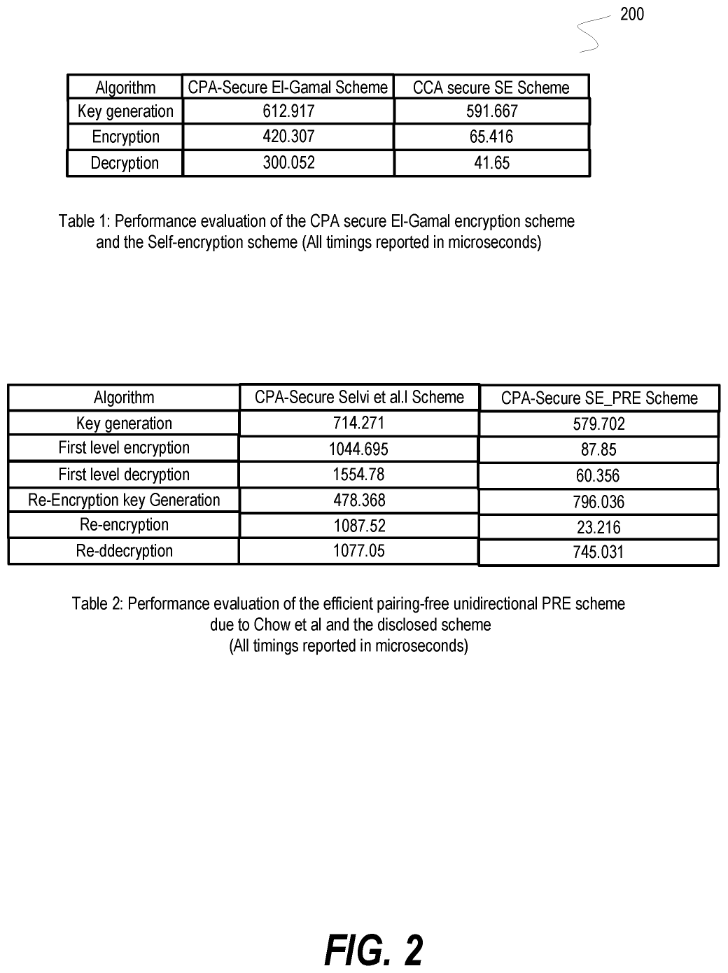

FIG. 2 shows Table 1 and Table 2. Table 1 discloses Performance Evaluation of the CPA secure El-Gamal Encryption Scheme and disclosed Self-Encryption Scheme. Table 2 discloses Performance Evaluation of the efficient pairing-free unidirectional PRE scheme due to Chow et al., and disclosed Scheme.

Experimental Analysis depicts the implementation results and time taken by various algorithms in SE and SE-PRE scheme. The efficiency of the disclosed CCA secure SE scheme is compared with the traditional CPA secure El-Gamal scheme (Weaker security than CCA) and reports the results in FIG. 2 Table 1. Also, the disclosed SE-PRE scheme is compared with the only non-pairing unidirectional CCA secure PRE scheme by others available. This is reported in FIG. 2 Table.2. It is a known fact that pairing is very expensive compared with than other group operations and hence other pairing based schemes are not compared. The implementations are done on 2.4 GHZ Intel Core i7 quad-core processor and the results have been reported below. The programming language used is Go language, and the programming tool is Goland 2018.2. The cryptographic protocols are implemented using the edwards25519-curve, which is the current standard deployed in cryptocurrencies for fast performances. From the performance comparison in FIG. 2 Table 1, it is noted that the disclosed CCA secure self-encryption SE scheme is more efficient than the existing CPA-secure El-Gamal encryption schemes. Also, from FIG. 2 Table 2, it is evident that the disclosed self-proxy re-encryption SE-PRE scheme without bilinear pairing is more efficient than the existing pairing-free PRE scheme by others.

From the above results it is evident that the disclosed SE encryption scheme is practical and suitable for cloud-based scenarios where the user themselves store their files. Also, the SE-PRE scheme provides a very efficient approach to share encrypted files mainly in block-chain.

The disclosed self-encryption scheme SE is based on discrete logarithm (DLP) assumption and then extended to a Proxy Re-Encryption (SE-PRE) scheme suitable for blockchain and distributed storage. First, we formally prove the CCA security of the SE and then the security of SE-PRE scheme in the random oracle model. We have also implemented our SE-PRE scheme using GO language. From the results of our implementation, it is evident that our SE-PRE scheme is much efficient than the techniques available in literature and industry till date. This makes it more suitable for distributed applications. A person of ordinary skill in the art would understand that one can design a multi-recipient or broadcast PRE based on the self encryption approach that will provide high efficiency gain in decentralized platforms.

I. Secure Content Access Audit with Blockchain

A fast finality blockchain is disclosed with a cost-effective solution that allows for independent verifiable audit capability along with providing end to end security for content from authoring to distribution.

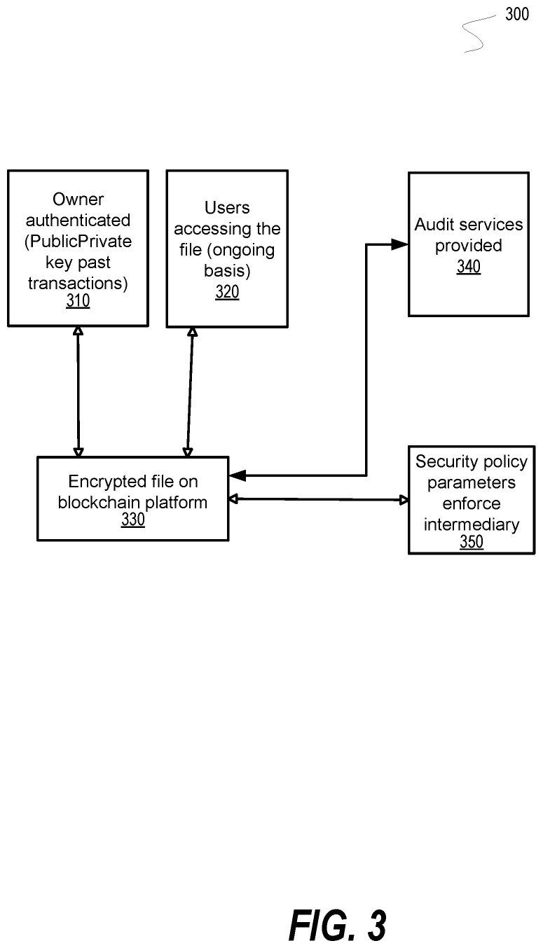

FIG. 3 discloses a data workflow 300 for an encrypted file that requires independent audit response. For example, encrypted file 330 is put on the blockchain platform by an authenticated owner 310. In one embodiment, the owner 310 is authenticated using proof of past public/private key transactions on the blockchain platform. In one embodiment, the owner 310 is authenticated using split-keys on two or more owner devices. In one embodiment, the owner 310 is authenticated using a combination of single signature on and split-key authentication techniques. Different users and clients 320 can access the encrypted file 330 on an ongoing basis according to security policy parameters set by owner. The security policy parameters for the encrypted file 330 are enforced by an intermediary 350. Another intermediary 340 can provide audit services for the encrypted file.

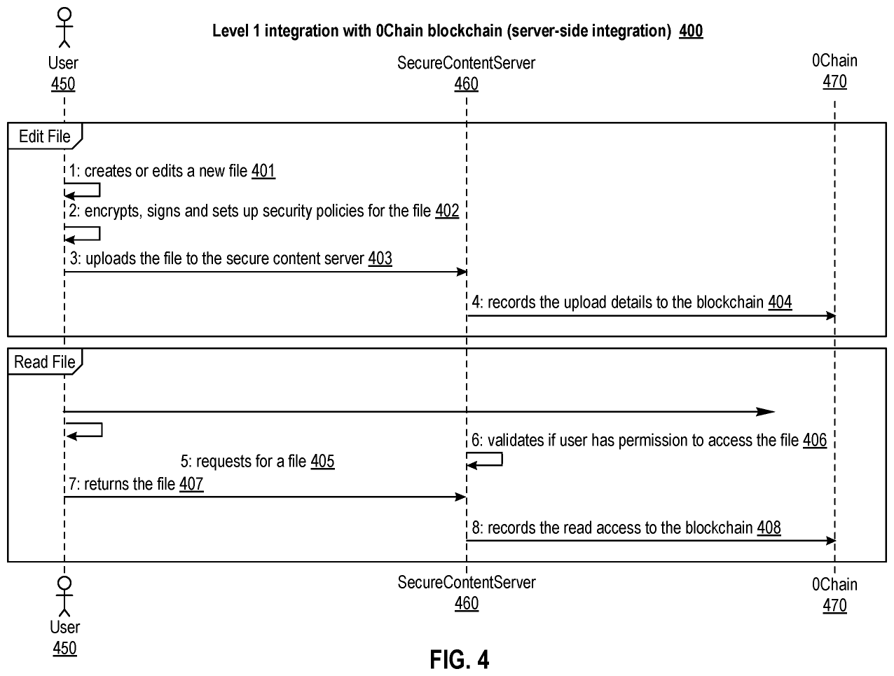

FIG. 4 depicts a level 1 Integration with 0Chain blockchain (server-side integration 400). FIG. 4 depicts integration at the server level. The idea here is that the end users will not have any changes to their workflows. Everything is taken care of at the server level. Whenever a user submits data or reads data, it is automatically recorded on the blockchain by the server. This level of integration provides tamperproof auditability with accurate timestamp information. It is assumed that the server is trusted at any given moment to submit the right data to the blockchain but will not be able to alter it later on.

The following step occur:
1) The user 450 creates or edits a new file at step 401.
2) Security policies are setup for the file including encryption and signing at step 402.
3) The file is uploaded to the secure content server 460 at step 403.
4) The uploaded file details are recorded on the blockchain 0chain 470 at step 404.
5) The user 450 requests the file from the secure content server 460 at step 405.
6) The secure content server 460 validates the user has permission to access the file at step 406.
7) The secure content server 460 returns the file to the user 450 at step 407.
8) The secure content server 460 records the read access to the blockchain at step 408.

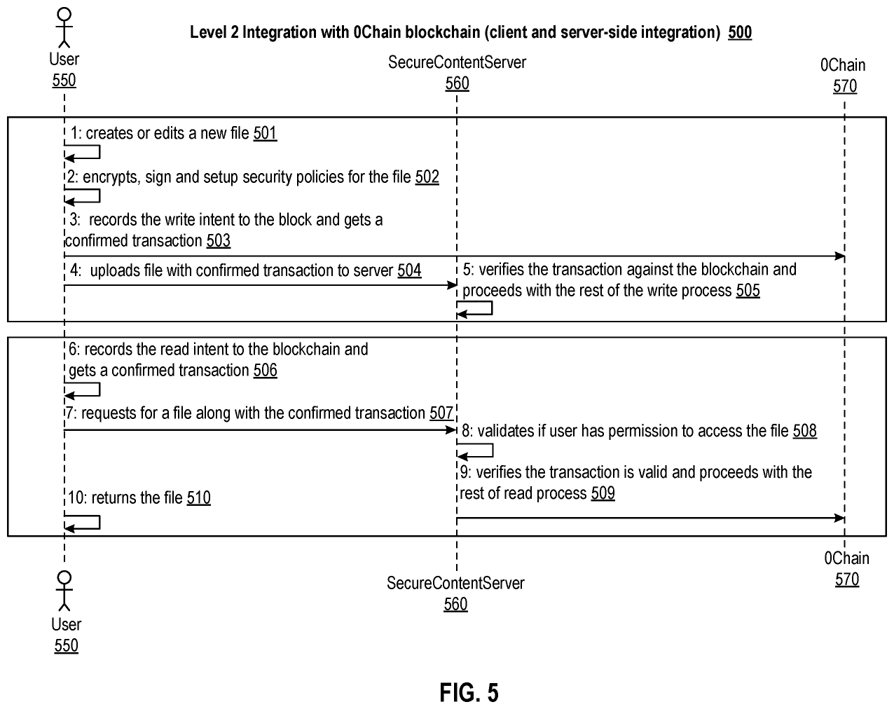

FIG. 5 depicts level 2 integration with 0Chain blockchain (client and server-side integration) 500. FIG. 5 shows integration at the server and client level. There may be cases where even the server can't be trusted. Or the enterprise wants the audit data to be provided by the client instead of the server. In this case, it is expected that each user has credentials with the blockchain and use those credentials to submit their read/write transactions and then present that as a proof to the server to access the content. The server can continue to enforce access control and even record any access that is not permitted presenting the transaction presented by the user to read the content.

The following step occur:
1) The user 550 creates or edits a new file at step 501.
2) Security policies are setup for the file including encryption and signing at step 502.
3) The write intent to 0Chain 570 is recorded and a confirmation transaction is returned at step 503.
4) The file is uploaded to with a confirmed transaction to the secure content server 560 at step 504.
5) The transaction against the blockchain is verified and the process proceeds with the rest of the writes at step 505.
6) The user 550 records a read intent on the blockchain 0chain 570 and receives a confirmed transaction at step 506.
7) The user 550 requests the file along with the confirmed transaction from the secure content server 560 at step 507.
8) The secure content server 560 validates the user has permission to access the file at step 508.
9) The secure content server 560 verifies the transaction is valid and proceeds with the rest of the read process at step 509.
10) The secure content server 560 returns the file to the user 550 at step 510.

In one embodiment, there is integration at the storage level for enterprises. There are cases where the enterprise prefers to have a zero-knowledge storage system. In this model, the storage of the data is done in a decentralized manner by storage providers and each has access to only a partial content that is also further secured via encryption. The end user controls the keys to the content and distribute it to users of their choice via proxy re-encryption keys.

### III. Multiple Signatures on a Smart Wallet

In one embodiment, a state of a smart wallet is tracked on the blockchain in a Merkle Patricia Tree (MPT), which captures critical state entries of the blockchain network. Users can add T-of-N multi-sig capabilities to MPT wallets by keeping track of signatures. Votes to send tokens must arrive one-per-transaction and are stored in public blockchain state, that is, recorded in the MPT. It's a smart contract code with an address, not a simple wallet address. A multi-sig wallet is a smart contract code with an address to process a transaction. So when a threshold of votes come in, the smart contract code can collate the signature in the BLS domain through a mathematical process previously described and execute the transaction.

A group signature on a description of transfer is recovered from the votes. Validation of the signature happens outside of the smart contract. State may be pruned safely, allowing amnesiac property of miners to be preserved without loss of security. In one embodiment, a single, shared smart contract collects votes for proposals to send tokens between wallets. In one embodiment, the wallet associated with the smart contract is not used and multiple-signatures (“multi-sig”) are sent directly on MPT based wallets. This removes the support for non-token-transfer operations guarded by a multi-sig, meaning in one embodiment, this design will not support data transactions or arbitrary smart contract calls. The policy of multi-sig is enforced automatically. In one embodiment, threshold cryptography will be utilized to create signatures for the exchange/corporate MPT wallet. In one embodiment, Shamir's secret sharing is used as a simple way to create keys capable of this feature. The approach uses a threshold scheme based on polynomial interpolation over finite fields. New transactions will not be dynamically created inside the smart contract. The blockchain may set up the construction of the polynomial utilizing BLS construction from an configured minimum number of points found on the graph of the polynomial

The benefits of implementing multiple signatures on a smart wallet include creation of multi-signature wallets, voting for transfers and pruning of old proposed transfers and votes. Any implementation has to consider the following before finalizing transactions on the smart wallet: querying whether multi-signature capabilities already exist; updating the list of signers and/or required number of votes; deletion of multi-signature capabilities for a wallet.

Allow creation of a multiple signature wallet context for a wallet. The transaction containing this request must be sent from the target wallet's client. It must include a list of voter public keys and the minimum number of votes that must be collected before funds may be sent from the wallet. If a wallet with this multi-sig wallet context already exists, it is an error. Don't disallow normal TxnTypeSend from a wallet for which a multi-sig wallet context exists. Allow creation of multi-sig transfer votes for a wallet. The votes must contain a proposal ID value to differentiate between multiple transfers of the same value to the same client. Different multi-sig wallet contexts may have proposals with the same ID. When a vote is sent with an ID not currently in the database, a proposal object is created in state. A vote must contain an inner signature produced by the vote's sender. This signature is on a message similar to the following:
${FromWalletID}:${ToWalletID}:${Value}

Add chaincore/chain/state_context.go#AddSignedTransfer( ) call that is similar to AddTransfer( ) but which also takes a signature and may be sent from any wallet. This AddSignedTransfer call reconstructs the message above and validates the passed signature against it and from the wallet's public key. If the signature is invalid, the call fails and the transfer is rejected.

When the required number of votes are collected on a multi-sig send proposal, it is executed. If the wallet does not have enough balance to complete the transaction, the vote transaction succeeds (so as to eligible to be included in a block) but does not count the vote toward the proposal and a transaction output message that there aren't enough funds. Because the vote is not counted, it allows the last voter to try again later. If the transfer succeeds, the proposal object that was allocated for this transfer is not deleted yet. This allows us to tell if additional votes arrive soon after the proposal was already executed.

Multi-sig proposals are assigned an expiration date by the smart contract. When the expiration date is past, a proposal is eligible for deletion.

When a vote comes in, the blockchain checks the oldest proposal it knows of (across all multi-sig wallets, not just the one being voted on) to see if it is expired. If so, it is deleted (“pruned”) and the ID value that the proposal held is free to be re-used by the originating multi-sig wallet. Only one proposal may be deleted per incoming vote to protect against any single vote transaction performing a large amount of IO. This will help to future-proof this multi-sig wallet scheme from any IO quota policy the blockchain might decide to one day start implementing.

If a vote comes in for a proposal that is past expiry but which has not been pruned yet, the proposal is immediately deleted (“pruned”) and a new proposal with the same ID is instantiated. This presents a consistent behavior between an expired-deleted and an expired-not-yet-deleted proposal.

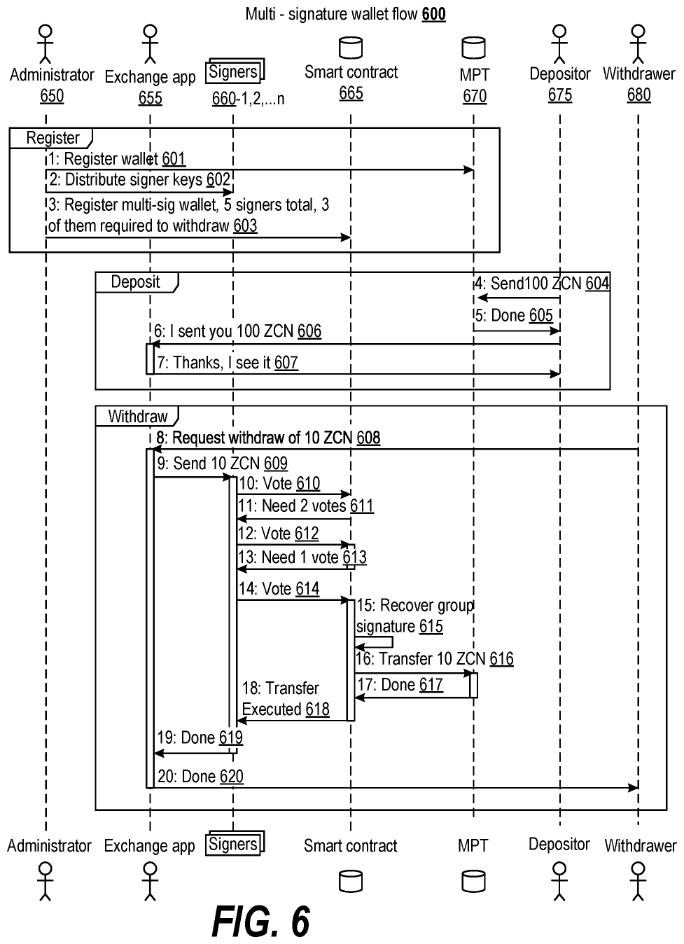

FIG. 6 depicts a multiple-signature wallet flow for messages between different entities 600. 650 is Administrator of the blockchain, 655 is the Exchange application for transactions, 660-1,2,3, . . . n are different multiple signers, 665 is the smart contract, 670 is the MPT, 675 is the depositor and 680 is the withdrawer. The figure shows register, deposit and withdraw events and corresponding messages according to one embodiment. Although not shown, a transaction identifier is associated with each transaction and processing verifies that the same transaction identifier is being used to process the same transaction. In some embodiments, initiating a new multi-signature wallet transaction with a new proposal id when the new proposal id was previously created may be treated as an error condition and prohibited by error checking logic.

The following steps occur:

For registration:
1) The Administrator 650 registers a wallet with the MPT at step 601.
2) Keys are distributed to the signers 660-1,2,3, . . . ,n at step 602.
3) The multi-signature wallet is registered with n=5 signers total, t=3 signers are required to withdraw with the smart contract 665 at step 603.

For deposit:
4) A depositor 675 sends 100 ZCN to the MPT 670 at step 604.
5) The MPT 670 indicates the deposit is done to the depositor 675 at step 605.
6) The depositor 675 tells the exchange app 655 that 100 ZCN were sent at step 606.
7) The exchange app 655 tells the depositor 675 “Thanks, I see it” at step 607.

For withdrawal:
8) The withdrawer 680 requests a withdrawal of 10 ZCN from the exchange app 655 at step 608. The exchange app coordinates votes by informing voters to sent their signatures to the blockchain in order to execute the transaction.
9) The exchange app 655 sends the withdrawal of 10 ZCN request to the signers 660-1,2,3, . . . n at step 609.
10) One signer votes to approve sending the approval vote to the smart contract 665 at step 610.
11) The smart contract 665 indicates to the signers 660-1,2,3, . . . n that two more approval votes are needed at step 611.
12) Another signer votes to approve sending the approval vote to the smart contract 665 at step 612.
13) The smart contract 665 indicates to the signers 660-1,2,3, . . . n that one more approval vote is needed at step 613.
14) Another signer votes to approve sending the approval vote to the smart contract 665 at step 614.
15) The smart contract detects that the required number of approval votes, three (3) have been received and recovers group signature at step 615.
16) The smart contract 665 requests the transfer of 10 ZCN from the MPT 670 at step 616.
17) The MPT transfers the 10 ZCN to the smart contract 665 at step 617.
18) The smart contract 665 indicates to the signers that the transaction has been executed at step 618.
19) The signers 660 inform the exchange app 655 that the withdrawal is done at step 619.
20) The exchange app 655 tells the withdrawer 680 that the withdrawal is done at step 620.

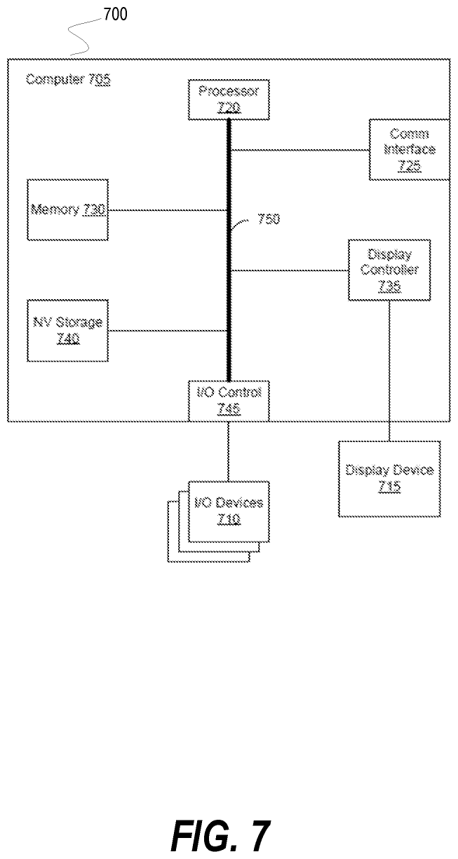

FIG. 7 is a schematic diagram of computing device 700 that can be used to implement the methods and systems disclosed herein, according to one or more embodiments. FIG. 7 is a schematic of a computing device 700 that can be used to perform and/or implement any of the embodiments disclosed herein. In one or more embodiments, client system 110, an intermediary system 120, service provider system 130 of FIG. 1 may be the computing device 700.

The computing device 700 may represent various forms of digital computers, such as laptops, desktops, workstations, personal digital assistants, servers, blade servers, mainframes, and/or other appropriate computers. The computing device 700 may represent various forms of mobile devices, such as smartphones, camera phones, personal digital assistants, cellular telephones, and other similar mobile devices. The components shown here, their connections, couples, and relationships, and their functions, are meant to be exemplary only, and are not meant to limit the embodiments described and/or claimed.

FIG. 7 shows an example of a computing device 700 on which techniques described here can be implemented. The computing device 700 can be a conventional computer system that can be used as a client computer system, such as a wireless client or a workstation, or a server computer system. The computing device 700 includes a computer 705, I/O devices 710, and a display device 715. The computer 705 includes a processor 720, a communications interface 725, memory 730, display controller 735, non-volatile storage 740, and I/O controller 745. The computer 705 may be coupled to or include the I/O devices 710 and display device 715.

The computer 705 interfaces to external systems through the communications interface 725, which may include a modem or network interface. It will be appreciated that the communications interface 725 can be considered to be part of the computing device 700 or a part of the computer 705. The communications interface 725 can be an analog modem, integrated services for digital networks (“ISDN”) modem, cable modem, token ring interface, satellite transmission interface (e.g. “direct personal computer” also known as “direct PC”), or other interfaces for coupling a computer system to other computer systems.

The processor 720 may be, for example, a conventional microprocessor such as an Intel Pentium microprocessor or Motorola power PC microprocessor. The memory 730 is coupled to the processor 720 by a bus 750. The memory 730 can be Dynamic Random Access Memory (DRAM) and can also include Static RAM (SRAM). The bus 750 couples the processor 720 to the memory 730, also to the non-volatile storage 740, to the display controller 735, and to the I/O controller 745.

The I/O devices 710 can include a keyboard, disk drives, printers, a scanner, and other input and output devices, including a mouse or other pointing device. The display controller 735 may control in the conventional manner a display on the display device 715, which can be, for example, a cathode ray tube (CRT) or liquid crystal display (LCD). The display controller 735 and the I/O controller 745 can be implemented with conventional well-known technology.

The non-volatile storage 740 is often a magnetic hard disk, an optical disk, or another form of storage for large amounts of data. Some of this data is often written, by a direct memory access process, into memory 730 during execution of software in the computer 705. One of skill in the art will immediately recognize that the terms “machine-readable medium” or “computer-readable medium” includes any type of storage device that is accessible by the processor 720 and also encompasses a carrier wave that encodes a data signal.

The computing device 700 is one example of many possible computer systems that have different architectures. For example, personal computers based on an Intel microprocessor often have multiple buses, one of which can be an I/O bus for the peripherals and one that directly connects the processor 720 and the memory 730 (often referred to as a memory bus). The buses are connected together through bridge components that perform any necessary translation due to differing bus protocols.

Network computers are another type of computer system that can be used in conjunction with the teachings described here. Network computers do not usually include a hard disk or other mass storage, and the executable programs are loaded from a network connection into the memory 730 for execution by the processor 720. A Web TV system, which is known in the art, is also considered to be a computer system, but it may lack some of the components shown in FIG. 7, such as certain input or output devices. A typical computer system will usually include at least a processor, memory, and a bus coupling the memory to the processor.

Though FIG. 7 shows an example of the computing device 700, it is noted that the term “computer system,” as used here, is intended to be construed broadly. In general, a computer system will include a processor, memory, non-volatile storage, and an interface. A typical computer system will usually include at least a processor, memory, and a device (e.g., a bus) coupling the memory to the processor. The processor can be, for example, a general-purpose central processing unit (CPU), such as a microprocessor, or a special-purpose processor, such as a microcontroller. An example of a computer system is shown in FIG. 7.

The memory can include, by way of example but not limitation, random access memory (RAM), such as dynamic RAM (DRAM) and static RAM (SRAM). The memory can be local, remote, or distributed. As used here, the term “computer-readable storage medium” is intended to include only physical media, such as memory. As used here, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory here. Even when software is moved to the memory for execution, the processor will typically make use of hardware registers to store values associated with the software, and local cache that, ideally, serves to speed up execution. As used here, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Several components described here, including clients, servers, and engines, can be compatible with or implemented using a cloud-based computing system. As used here, a cloud-based computing system is a system that provides computing resources, software, and/or information to client systems by maintaining centralized services and resources that the client systems can access over a communications interface, such as a network. The cloud-based computing system can involve a subscription for services or use a utility pricing model. Users can access the protocols of the cloud-based computing system through a web browser or other container application located on their client system.

The invention disclosure describes techniques that those of skill in the art can implement in numerous ways. For instance, those of skill in the art can implement the techniques described here using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used here, the term ‘processor’ refers to one or more devices, circuits, and/or processing cores configured to process data, such as computer program instructions.

A detailed description of one or more implementations of the invention is provided here along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Techniques described here relate to apparatus for performing the operations. The apparatus can be specially constructed for the required purposes, or it can comprise a general-purpose computer selectively activated or reconfigured by a computer program stored in the computer. Such a computer program may be stored in a computer-readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus. Although the foregoing implementations have been described in some detail for purposes of clarity of understanding, implementations are not necessarily limited to the details provided.

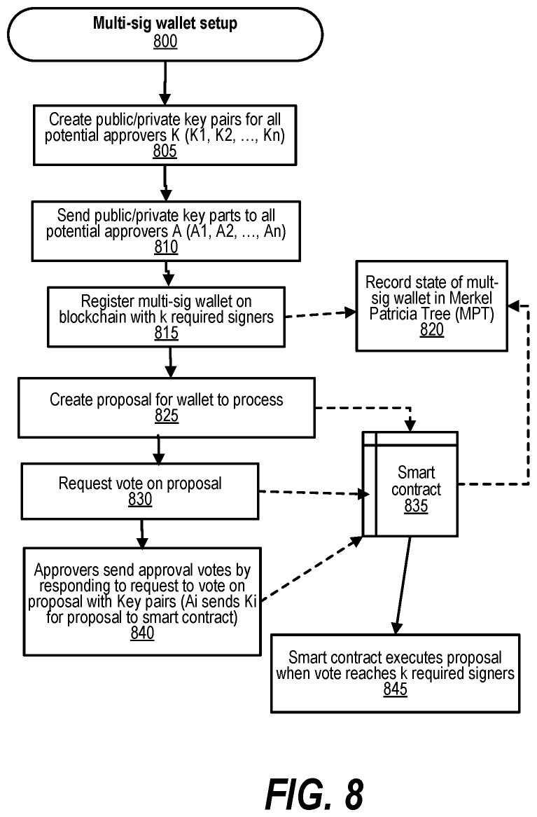

FIG. 8 processing commences at 800 and shows the steps taken by a process that handles multi-sig wallet setup. In an embodiment, a user or administrator may issue commands supported by the blockchain system to cause the steps to occur. At step 805, the process creates public/private key pairs for all potential approvers K (K1, K2, . . . , Kn). At step 810, the process sends public/private key pairs to all potential approvers A (A1, A2, . . . , An). At step 815, the process registers multi-sig wallet on blockchain with k required signers out of n possible signers. At step 820, the process records a state of mult-sig wallet in the MPT. At step 825, the process creates a proposal for multi-sig wallet to process. In an embodiment, the request to create the proposal may be requested via an interface supported in smart contract 835. At step 830, the process requests the approvers to sign off on the proposal which may again be initiated using an interface found in smart contract 835. The smart contract 835 may send the request to sign off on the proposal to the approvers identified in the multi-sig wallet. At step 840, the approvers send approval votes by responding to request to approve the proposal using their public key (Ai sends public key from the public/private key pair Ki) in response to the request to sign off on the proposal to the smart contract. At step 845, the smarts contract executes proposal when vote reaches k required signers.

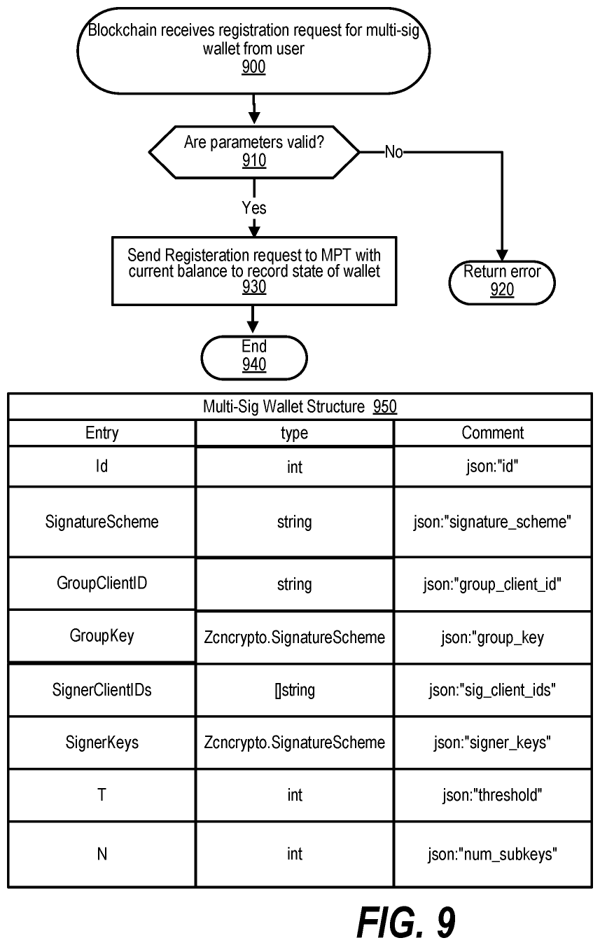

FIG. 9 processing commences at 900 and shows the steps taken to process a request to register multi-sig wallet on the blockchain. The process determines as to whether are parameters valid (decision 910). If are parameters valid, then decision 910 branches to the ‘Y’ branch. On the other hand, if parameters are not valid, then decision 910 branches to the ‘N’ branch. FIG. 9 processing returns to the calling routine at step 920. FIG. 9 processing thereafter ends at 940. An embodiment of a multi-Sigs Wallet Structure 950 is depicted in FIG. 9. Structure entries may use Javascript Object Notation (JSON) open standard file format and data interchange format that uses human-readable text to store and transmit data objects consisting of attribute-value pairs and arrays (or other serializable values. As shown the structure includes an identification (Id) of type int, a signature scheme (SignatureScheme) of type string that tells the blockchain system the type of signatures and signature processing to use on the wallet. For the multi-Sig wallet an append signature scheme is specified using BLS processing to reconstruct a full signature from a required number of signatures is indicated. A group client id (GroupClientID) of type string is used to ensure signers belong to the same group to validate the signer is authorized to sign against a proposal with the same authority as a previous signer. The group key (GroupKey) of type Zencrypto.SignatureScheme tells the system the type if signature scheme required to combine the signatures and validate the signatures. The signer client ids (SignerClientIDs) of type an array of strings list the IDs of allowable signers. The Signer keys of type Zencrypto. SignatureScheme tells the system type if signature scheme required to combine the signatures and validate the signatures. The Threshold (T) of type int identifies the required number of combined signatures needed before acting on a proposal. The total number (N) of public/private key pairs. The structure supports selecting different approvers for different proposals, so that many different proposals may be created and processed against the same multi-sigs Wallet at the same time. In an example embodiment, one or more multi-signature wallet proposals contains a first proposal tailored for a first initiator and a second proposal tailored for a second initiator and the first proposal is different from the second proposal.

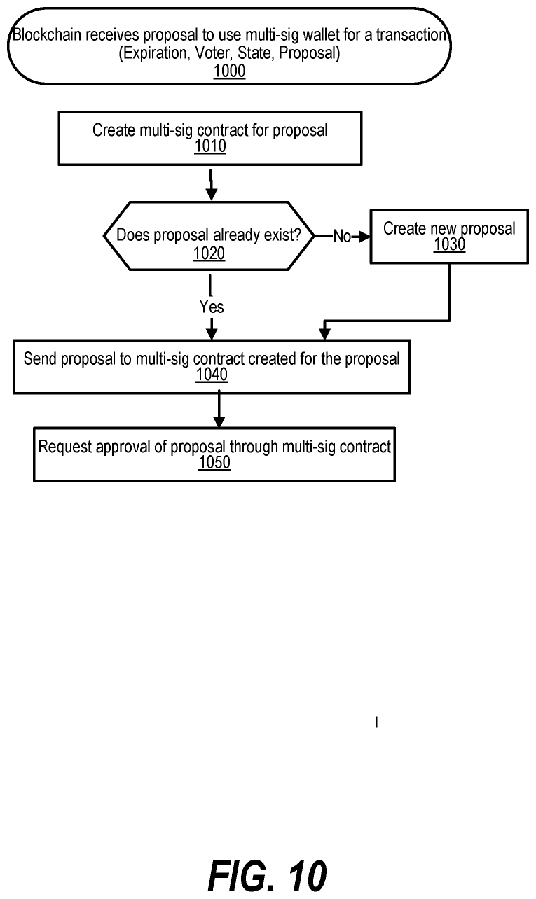

FIG. 10 processing commences at 1000 and shows the steps taken by a blockchain process that receives a proposal to use multi-sig wallet for a transaction Tx with parameters including, but not limited to, expiration, voters, state, and proposal. At step 1010, the process creates multi-sig contract for proposal. The process determines as to whether does proposal already exist (decision 1020). If does proposal already exist, then decision 1020 branches to the ‘Y’ branch. On the other hand, if not does proposal already exist, then decision 1020 branches to the ‘N’ branch. At step 1030, the process creates new proposal. At step 1040, the process sends proposal to multi-sig contract created for the proposal. At step 1050, the process requests approval of the proposal through multi-sig contract.

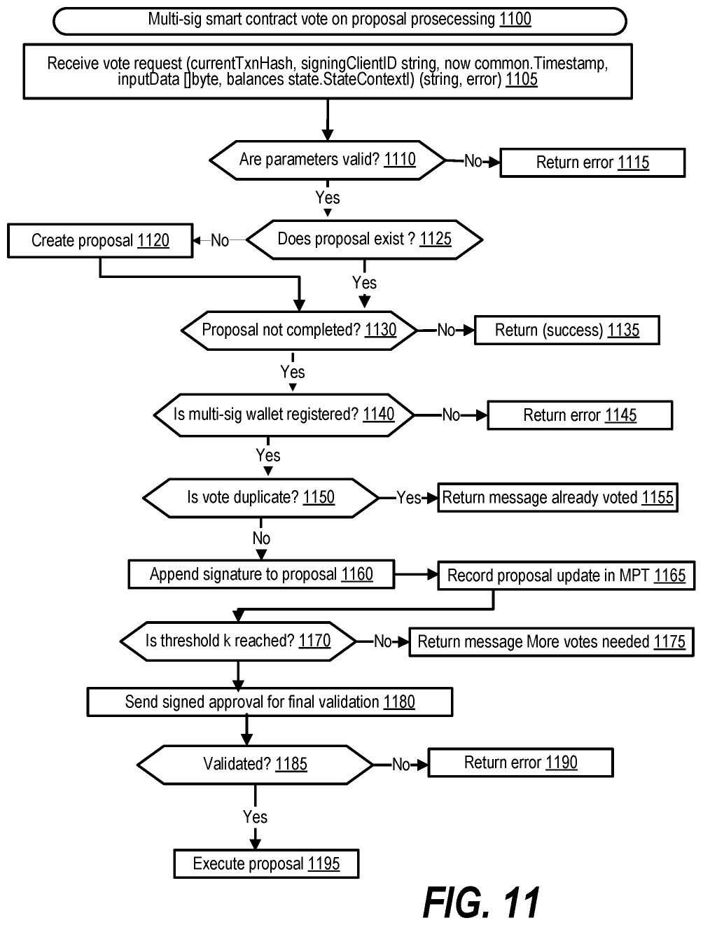

FIG. 11 processing commences at 1100 and shows the steps taken by a process to approve processing the proposal via the multi-sig smart contract. Note that a specified minimum number of approvers t, must approve the proposal for any action to be taken on the proposal. At step 1105, the process receives approval request from a responder. Note that there is no outcome difference between not approving and providing a no to the proposal vote. To approve the proposal an approver signs a request for approval with parameters including currentTxnHash, signingClientID string, now common. Timestamp, inputData [ ]byte, balances state.StateContextl. The process determines as to whether are parameters valid (decision 1110). If are parameters valid, then decision 1110 branches to the ‘Y’ branch. On the other hand, if not are parameters valid, then decision 1110 branches to the ‘N’ branch. FIG. 11 processing thereafter returns to the calling routine at 1115 with an error indication. The process determines as to whether does proposal exist (decision 1125). If does proposal exist, then decision 1125 branches to the ‘Y’ branch. On the other hand, if not does proposal exist, then decision 1125 branches to the ‘N’ branch. At step 1120, the process creates proposal. The process determines as to whether proposal not completed (decision 1130). If proposal not completed, then decision 1130 branches to the ‘Y’ branch. On the other hand, if not proposal not completed, then decision 1130 branches to the ‘N’ branch. FIG. 11 processing thereafter returns to the calling routine at 1135. The process determines as to whether is multi-sig wallet registered (decision 1140). If is multi-sig wallet registered, then decision 1140 branches to the ‘Y’ branch. On the other hand, if not is multi-sig wallet registered, then decision 1140 branches to the ‘N’ branch. FIG. 11 processing thereafter returns to the calling routine at 1145. The process determines as to whether is vote duplicate (decision 1150). If is vote duplicate, then decision 1150 branches to the ‘Y’ branch. On the other hand, if not is vote duplicate, then decision 1150 branches to the ‘N’ branch. FIG. 11 processing thereafter returns to the calling routine at 1155. At step 1160, the process appends signature to proposal. At step 1165, the process records proposal update in MPT. The process determines as to whether is threshold k reached (decision 1170). If is threshold k reached, then decision 1170 branches to the ‘Y’ branch. On the other hand, if not is threshold k reached, then decision 1170 branches to the ‘N’ branch. FIG. 11 processing thereafter returns to the calling routine at 1175. At step 1180, the process sends signed approval for final validation. The process determines as to whether validated (decision 1185). If validated, then decision 1185 branches to the ‘Y’ branch. On the other hand, if not validated, then decision 1185 branches to the ‘N’ branch. FIG. 11 processing thereafter returns to the calling routine at 1190. At step 1195, the process executes the proposal.

The memory can include, by way of example but not limitation, random access memory (RAM), such as dynamic RAM (DRAM) and static RAM (SRAM). The memory can be local, remote, or distributed. As used here, the term “computer-readable storage medium” is intended to include only physical media, such as memory. As used here, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory here. Even when software is moved to the memory for execution, the processor will typically make use of hardware registers to store values associated with the software, and local cache that, ideally, serves to speed up execution. As used here, a software program is assumed to be stored at an applicable known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, a computer system can be controlled by operating system software, which is a software program that includes a file management system, such as a disk operating system. One example of operating system software with associated file management system software is the family of operating systems known as Windows® from Microsoft Corporation of Redmond, Washington, and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Several components described here, including clients, servers, and engines, can be compatible with or implemented using a cloud-based computing system. As used here, a cloud-based computing system is a system that provides computing resources, software, and/or information to client systems by maintaining centralized services and resources that the client systems can access over a communications interface, such as a network. The cloud-based computing system can involve a subscription for services or use a utility pricing model. Users can access the protocols of the cloud-based computing system through a web browser or other container application located on their client system.

The invention disclosure describes techniques that those of skill in the art can implement in numerous ways. For instance, those of skill in the art can implement the techniques described here using a process, an apparatus, a system, a composition of matter, a computer program product embodied on a computer-readable storage medium, and/or a processor, such as a processor configured to execute instructions stored on and/or provided by a memory coupled to the processor. Unless stated otherwise, a component such as a processor or a memory described as being configured to perform a task may be implemented as a general component that is configured to perform the task at a given time or a specific component that is manufactured to perform the task. As used here, the term ‘processor’ refers to one or more devices, circuits, and/or processing cores configured to process data, such as computer program instructions.

A detailed description of one or more implementations of the invention is provided here along with accompanying figures that illustrate the principles of the invention. The invention is described in connection with such implementations, but the invention is not limited to any implementation. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

What is claimed is:

1. A method for preventing changing and executing of a multi-signature smart wallet until a group key is signed with a threshold number of signatures comprising:
creating, by a client, k out of n public-private key pairs for a multi-signature smart wallet wherein k is a required threshold number of public-private key pairs to process the multi-signature smart contract and n is the total number of public-private key pairs;
initiating a first transaction to register, by the client, the multi-signature smart wallet on a blockchain platform with the k out of n public-private key pairs;
registering the multi-signature smart wallet in an MPT to record a state of the multi-sig smart wallet;
sending, by the client, the n public-private key pairs to n approvers;
creating a second transaction to create a proposal that utilizes the multi-signature smart wallet;
creating a third transaction to vote on the proposal; and
receiving, a signed approval of the proposal from at least k voters, by the multi-signature smart wallet before allowing funds from the multi-signature smart wallet to be utilized for the proposal.

2. The method of claim 1, further comprising:
responsive to validating the shared signature utilizing public keys of the two or more users and the approved proposal id equals the proposal id for the multi-signature smart wallet, adding the shared signature to a reconstructed multi-signature context utilizing a public key of the multi-signature smart wallet; and
validating and finalizing the transaction when the received signatures are at-least the threshold number.

3. The method of claim 1, wherein the smart contract is initialized with a plurality of multi-signature wallet proposals.

4. The method of claim 3, wherein the plurality of multi-signature wallet proposals contains a first proposal tailored for a first initiator and a second proposal tailored for a second initiator and the first proposal is different from the second proposal.

5. The method of claim 1, further comprising:
preventing initiating a new multi-signature wallet transaction with a new proposal id when the new proposal id was previously created.

6. The method of claim 1, further comprising:
preventing execution of an expired proposal.

7. A system for preventing changing and executing of a multi-signature smart wallet until a group key is signed with at least two signatures, comprising:
one or more processors;
a memory coupled to at least one of the processors;
a network interface that connects the local node to one or more remote nodes; and
a set of computer program instructions stored in the memory and executed by at least one of the processors in order to perform actions comprising:
creating, by a client, k out of n public-private key pairs for a multi-signature smart wallet wherein k is a required threshold number of public-private key pairs to process the multi-signature smart contract and n is the total number of public-private key pairs;
initiating a first transaction to register, by the client, the multi-signature smart wallet on a blockchain platform with the k out of n public-private key pairs;
registering the multi-signature smart wallet in an MPT to record a state of the multi-sig smart wallet;
sending, by the client, the n public-private key pairs to n approvers;
creating a second transaction to create a proposal that utilizes the multi-signature smart wallet;
creating a third transaction to vote on the proposal; and
receiving, a signed approval of the proposal from at least k voters, by the multi-signature smart wallet before allowing funds from the multi-signature smart wallet to be utilized for the proposal.

8. The system of claim 7, wherein the smart contract is initialized with a plurality of multi-signature wallet proposals.

9. The system of claim 8, wherein the plurality of multi-signature wallet proposals contains a first proposal tailored for a first initiator and a second proposal tailored for a second initiator and the first proposal is different from the second proposal.

10. The system of claim 7, further comprising:
preventing initiating a new multi-signature wallet transaction with a new proposal id when the new proposal id was previously created.

11. The system of claim 7, further comprising:
prevent execution of an expired proposal.
